(19) United States
(12) Patent Application Publication
(10) Pub. No.: US 2008/0133573 A1
(43) Pub. Date: Jun. 5, 2008

(54) Relational Compressed Database Images (for Accelerated Querying of Databases)

(76) Inventors: Michael Haft, Zorneding (DE); Oliver Mihatsch, Munchen (DE); Reimar Hofmann, Munchen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/793,802

(22) PCT Filed: Dec. 19, 2005
(86) PCT No.: PCT/DE05/02287

§ 371 Date: Feb. 14, 2008

(30) Foreign Application Priority Data
Dec. 24, 2004 (DE) 10 2004 062 532.8

(51) Int. Cl. G06F 17/30

(52) U.S. Cl. 707/102; 707/E17.005

(57) ABSTRACT

The invention relates to a data bank interrogation system, wherein two or more data bank tables are linked by means of a common key or several keys which are respectively common to at least two data bank tables. In an analysis query and a selection of data sets in the first data bank, a selection of data sets is determined in the second data bank corresponding to the selection according to the common key and the analysis query is answered using the thus selected data sets in the second data bank.

### TECHNICAL FIELD

The invention relates to a database query system and to a method for computer-aided database querying.

### BACKGROUND OF THE INVENTION

The systematic acquisition of information about processes in companies is widespread. Having been acquired in the form of data and stored in suitable fashion, such information can be used for business management purposes and/or strategic marketing purposes, for example, depending on the type of information.

Thus, by way of example, information about customers making purchases in a construction market is collected and the data acquired in this manner, for example the age of the customers and the residential location of the customers, are analyzed in order to match the range of products provided on the construction market accordingly or to be able to better estimate what advertising strategies might be successful.

A statistical statement which is based on such acquired data only has any great significance when a very large volume of data or data records has been acquired, however. By way of example, for a construction market it makes no sense to change its range of products just because eight out of a total of ten customers surveyed in a survey have given corresponding responses.

To obtain a meaningful and significant result, it is therefore necessary to acquire a large volume of data, to structure them in suitable fashion, to store them, that is to say to store them in a database, and to analyze them, that is to say to evaluate them statistically.

Despite the relatively powerful computer systems available today, this is not a trivial task.

In respect of memory requirement, necessary time for accessing the data stored in the database and cost, it is of great significance to store and manage databases efficiently.

Furthermore, conventional database systems do not allow certain questions to be answered at all, or allow them to be answered only with a high level of complexity.

By way of example, a construction market might have a customer database table which stores information about the customers in the construction market in the form of customer data records. A customer data record contains the customer's customer number, the customer's sex and the customer's year of birth, for example.

The construction market could also have a transaction database table which stores information about transactions, that is to say sales transactions, in the form of transaction data records. By way of example, a transaction database might contain a transaction number, a specification for the product sold in the transaction, the statement indicating the sales in the transaction, the statement of the date of the day on which the transaction was performed, the customer number of the customer who was involved in the transaction, and a specification for the payment type used by the customer (cash payment, card payment).

It will now be assumed that a sales manager in the construction market would like to know the age distribution of the customers who purchased bedding and balcony plants in January.

The sales manager cannot answer this question by querying the first database table or the second database table, however.

By querying the first database table, the sales manager cannot answer the question because the first database table does not contain any information about the products purchased by a customer.

By querying the second database table, the sales manager cannot answer the question because the second database table does not contain any information about the age of the customers who have performed the transactions.

All the relational databases currently on the market have the possibility of linking a plurality of database tables via common key fields (in the example above, for example, customer number). Such so-called “JOIN” operations often involve a high level of computation, however. Many database systems used today are at beyond the limit for their response times and utilization level. A large proportion of these problems are caused by queries which link a plurality of database tables and contain complicated selection criteria which extend over a plurality of database tables.

Queries which relate to just a single database table can be handled by what is known as a “full table scan”, i.e. by reading the complete database table once from the hard disk (or another memory) into the main memory and processing each data record individually. The delay time for such queries thereby finds a natural upper limit. If a plurality of database tables are linked, this simple procedure no longer works, and potentially very long query times may arise.

A possible alternative which is sometimes taken in the field of data warehousing is to alter the structuring of the information in various database tables such that all the information required for a query is ultimately contained in a single database table.

The question could be answered by querying the first database table if each customer data record were to contain the information regarding whether the customer corresponding to this customer data record has purchased bedding and balcony plants in January. Accordingly, a customer data record could have a field which contains a first value if the customer has purchased bedding and balcony plants in January and contains a second value if the customer has not purchased any bedding and balcony plants in January.

It can be seen that for such a query the structure of the database table needs to have been chosen accordingly before the actual query. In this example, the customer database table needs to be in a form such that each customer data record contains the information regarding whether the relevant customer has purchased bedding and balcony plants in January. This is not readily possible, however, since it is typically not possible to see what queries will be made to the database table in future when the database table is actually designed.

The customer database table could be designed such that it can be used to answer a multiplicity of queries. By way of example, each customer data record could contain the information regarding whether the customer has purchased bedding and balcony plants in January, whether the customer has purchased bedding and balcony plants in February and so on for all months and also whether the customer has purchased screws in January, whether the customer has purchased screws in February and so on for all products and months.

However, this practice results in a customer database table of unacceptable size.

The customer database table likewise grows substantially if each customer data record incorporates a list of the products purchased by the respective customer. To be able to answer the question above, such a list would, in particular, also need to be used to store the month of sale for each purchased product. If queries which relate to the type of payment used by the customers for purchasing the product are also to be expected then appropriate information likewise needs to be incorporated into the customer database table. According to the queries to the customer database table which are to be expected, this case may likewise necessitate a customer database table of unacceptable size if what is known as a flat data structure is used for the customer database table. In particular, storing a list of products and supplementary information is a problem, since the length of this product list can vary greatly from customer to customer but database tables usually contain a fixed number of fields for all data records. It is thus either necessary to provide a large number of fields (1st product, . . . 100th product) so that everything can be stored even for customers with extensive purchases or the product list is cut down for some customers, i.e. is not stored completely, or the list is stored using a field of suitable data type which supports a variable length for the product list (e.g. using a field of a string data type). However, the latter solution has the drawback that queries which relate to this field are complex and inefficient to process, especially if supplementary attributes of the products are involved (for example the query “show all customers who have purchased a product from the technical division for more than 100 euros in August”).

An acceptable size for the customer database table can be achieved if information (from the transaction database table) is inserted into the customer database table in aggregated form, for example if each customer has the information incorporated regarding whether he has performed any transaction in January, has performed any transaction in February and so on. This does not allow the query above to be answered, however, since the information is not included in the customer database table with sufficient accuracy.

In summary, conventional relational database systems can either store the data with efficient memory use and in easy-to-manage form in what is known as a normalized scheme using various database tables, with the drawback that (analytical) queries are very inefficient, or can construct a flat “denormalized” data scheme with just one or a few database tables, which speeds up analyzes but takes up a lot of memory, is inflexible and is difficult to service.

In [1] probability models are described, such as Bayesian networks and Markov networks.

[2] discloses methods for learning dependency structures forming the basis of a data record, using Bayes networks and Markov networks.

In [3] various statistical learning methods are described.

[4] discloses a method for arithmetic encoding of data.

In [5] a method is described in which a Gaussian hybrid model is used for a database with continuous entries in order to answer queries to the database in approximative fashion.

[6] discloses the production of a statistical clustering model for a database which can be used to efficiently answer queries to the database in approximative fashion.

Various methods are known which allow data to be structured, efficiently stored and analyzed:

[7] describes Z ordering.

[8] describes K* trees.

In [9] the IGrid index is described.

In [10] inference methods are described.

In [11] a method is described in which a first statistical image for a database is formed which represents the statistical connections for the data elements contained in the first database. Next, the first statistical image is stored in a computer server and is transmitted by the latter to a client computer via a communication network. The received first statistical image is processed further by the client computer.

Document [12] discloses a method for managing data using a multidimensional database. A data aggregation server is set up to transmit requested aggregated data to client units.

### SUMMARY OF THE INVENTION

According to one embodiment of the invention the problem of providing a way of ascertaining results for queries whose ascertainment requires data from a plurality of database tables more efficiently, less computation-intensively and less memory-intensively in comparison with the prior art is solved.

According to one embodiment of the invention a database query system is provided having a first database image of a first database table containing a first multiplicity of data records and a second database image of a second database table containing a second multiplicity of data records. Each data record in the first multiplicity of data records and each data record in the second multiplicity of data records has an associated value for a database key. The database query system has an input device which is set up to receive an analysis query to the second database image, a selection device which is set up to select a portion of the first multiplicity of data records in line with a first selection, an ascertainment device which is set up to ascertain a second selection of a portion of the second multiplicity of data records, wherein in accordance with the second selection such data records are selected which have associated values for the database key which are respectively associated with at least one data record which has been selected in line with the first selection, and also a processing device which is set up to ascertain the result of the analysis query on the basis of the portion of the second multiplicity of data records.

According to another embodiment of invention a method for computer-aided database querying in line with the database query system described above is provided.

### BRIEF DESCRIPTION OF THE FIGURES

Exemplary embodiments of the invention are illustrated in the figures and are explained in more detail below.

FIG. 1 shows a computer arrangement based on an exemplary embodiment of the invention.

FIG. 2 shows a first screen display for an explorer computer program based on an exemplary embodiment of the invention.

FIG. 3 shows a second screen display for an explorer computer program based on an exemplary embodiment of the invention.

FIG. 4 shows a third screen display for an explorer computer program based on an exemplary embodiment of the invention.

FIG. 5 shows a fourth screen display for an explorer computer program based on an exemplary embodiment of the invention.

FIG. 6 shows a fifth screen display for an explorer computer program based on an exemplary embodiment of the invention.

FIG. 7 shows a sixth screen display for an explorer computer program based on an exemplary embodiment of the invention.

FIG. 8 illustrates a cluster hierarchy in line with a database image based on an exemplary embodiment of the invention.

FIG. 9 illustrates a cluster based on an exemplary embodiment of the invention.

### DETAILED DESCRIPTION

Illustratively, the data records in the first database table and the data records in the second database table, which contain associated information, are linked by means of a database key and are stored in compressed form as database images. The database images store the values of the database key for the data records. Associated information is information which relates to the same person or thing, for example the second database table contains data records with information about customers in a construction market and the first database table contains information about transactions performed in the construction market. In this example, a data record in the second database table and a data record in the first database table contain associated information if the data record in the first database table contains information about a transaction which has been performed by the customer about which the data record in the second database table contains information. The database key linking the two data records could in this example be a customer number for the customer which is contained in both data records.

A database key may comprise a single data field in a database table (e.g. a customer number describes a customer in a customer table explicitly), or may comprise a combination of a plurality of data fields (e.g. the combination of a branch number and a customer number within the branch).

Illustratively, a query to the second database table, that is to say a query to the second database image, which also requires information from the first database table in order to be answered, is answered by virtue of data records being selected in the first database image in line with the required information, that is to say data records being selected for which a particular condition is met. Next, the relevant data records in the second database image are selected, that is to say that the data records in the second database image are selected which correspond to the selected data records in the first database image according to the linking by means of the database key. The selected data records can be taken as a basis for answering the query, since the necessary information from the first database image has been used to generate the selection of the data records in the second database image.

An idea on which embodiments of the invention is based can be seen in that each database table involved is provided with a database image which contains certain information from the database table in compressed form. This database image is usually much smaller than the original database table and is also better suited to particular operations on account of its structure. This allows certain database queries to be answered more quickly on the basis of the database image (or a combination of information from the database image and a remaining simpler query to the database) than from the original database alone. In particular, the text below describes how database images can be linked to one another (as an example, with a result in line with a JOIN operation from two database tables). In such cases, particularly great advantages are obtained because these operations can be particularly complex in normal databases.

Illustratively, the first database image and the second database image, which are linked by means of the data key, as explained, form a compressed relational structure.

The use of database images instead of the database tables themselves achieves faster access, since the first database image and the second database image can be stored in a memory to which rapid access is possible, for example a main memory in a computer.

In tandem with the described method for speeding up queries in relational structures, a method is described which allows efficient initiation of relational queries in a graphical interface by using the accelerated query times.

The first database table and the second database table may be two database tables created from two different perspectives from the point of view of database architecture. As in the example above, the first database table contains a respective data record for the customers in the construction market, which contains information about the respective customer, and the second database table contains a respective data record for the transactions performed in the construction market, which contains information about the respective transaction, for example.

By way of example, as above, the second database table might contain data records containing information about customers in a construction market, inter alia the age of the respective customer, but not when the customer has performed a transaction in the construction market, and the first database table might contain information about transactions performed in the construction market, inter alia the date of the respective transaction, but not how old the customer is who performed the transaction. For a query to the second database table, based on the average age of the customers who have performed a transaction in May, the first database table needs to provide the information regarding what transactions have been performed in May. These are selected and the database key is used to select the data records in the second database table which contain information about customers who have performed a transaction in May. The query can then be answered on the basis of the selected data records in the second database table.

In this way, it is possible to answer queries to the second database table whose answers require information from the first database table without transferring the information to the second database table, for example in the form of a list or additional entries in the data records in the second database table.

The user can therefore perform complicated statistical analyzes efficiently and easily.

Illustratively, evaluation of the second database table does not require supplementary information from the first database table to be permanently checked using a database key. This allows substantial computation complexity to be saved and a significant efficiency advantage is obtained over conventional databases for a query of such type.

The first database table and the second database table may be stored in a memory device in the database query system. In particular, they can be stored in distributed form, for example using a plurality of data server computers which are coupled by means of a communication network.

In this case of distributed database tables, the use of the invention is of particular advantage because, as explained above, the evaluation of the second database table does not require permanent access to supplementary information in the first database table, which would require substantial complexity, particularly communication complexity, in particular in the case of distributed database tables.

In one embodiment, evaluations and/or selections in the first database table and in the second database table can be performed simultaneously. For a selection in the first database table and simultaneous (additional) selection in the second database table, a query is based on the data records corresponding to the selections. In the example above, it would be possible to select in the first database table, for example, all transactions (or the relevant transaction data records) in which bedding and balcony plants were sold. In addition, it would be possible to select in the second database table all customers (all the relevant customer data records) who were older than 59 years. A query to the first database table and/or to the second database table is then answered on the basis of the transaction data records which correspond to transactions in which a customer who is older than 59 years has purchased (at least) a bedding and balcony plant or on the basis of the customer data records which correspond to customers who are older than 59 years and have purchased at least a bedding and balcony plant.

Illustratively, to this end the database tables export a list of the database keys which corresponds to the respective selection (“of their own”), and import the list from the respective other database table, which is combined with the selection “of their own”.

In one embodiment, in similar fashion more than two database tables are linked in the manner described. These can be linked using a common (to all database tables) database key or else using a plurality of database keys which are common in pairs. By way of example, a customer table and a till receipt table could be linked by means of a customer number, and the till receipt table could be linked to a transaction table by means of a till receipt number.

Illustratively, there is a common database key for each link between two respective database tables, and all database tables are in this way linked directly (by means of a common database key) or indirectly (via the “indirect route” of a further database table).

The most common type of database systems are relational databases. A relational database is typically understood to mean a software system which manages one or more database tables in a database. Each database table may contain a large number of data records (for example a customer table may contain one data record per customer, a transaction table may contain one data record per transaction). Each data record and a database table contains values for the same fields (for example customer number, age, sex).

As an example, embodiments of the invention relate to the linking of a plurality of such database tables. The database tables may come from the same database or else from different databases.

Embodiments of the invention can be found in the dependent claims. The further refinements of the invention which are described in connection with the database query system also apply mutatis mutandis to the method for computer-aided database querying.

For example, the first compressed database image and/or the second compressed database image are generated in line with a statistical model.

In one embodiment, the first compressed database image and the second compressed database image are database images created independently of one another.

For example, the statistical model is a graphical probability model. By way of example, a Bayesian network is used as a probability model.

In the embodiment described below, it is not only possible to achieve low memory complexity using the database images, but also the structure of the database images can be used for efficient and rapid access.

It is also possible for the input device also to be set up to receive a selection instruction and for the selection device to be set up to select the portion of the first multiplicity of data records in line with the selection instruction.

Illustratively, a user can select data records in order to specify a query more precisely and to ascertain results for complicated queries.

It is also possible for the database query system to have a display device which is set up to show a screen display which comprises the display of possible values for at least one random variable for which the first multiplicity of data records contains values, and for the selection instruction to be the selection of the display of at least one possible value (for one possible form) for the random variable, and for the first selection to involve all the data records in the first multiplicity of data records being selected for which the random variable assumes one of the selected at least one possible values.

In this way, a user can easily select data records, for example by clicking on a value of a random variable using a computer mouse.

It is also possible for the display device also to be set up to show a further screen display which comprises a display of the result of the analysis query, and for the display device also to be set up to change between the screen display and the further screen display.

Illustratively, a user can therefore use the screen display to select data records and then to change to the further screen display, so that the analysis results corresponding to the selection are displayed.

It is also possible for the database query system to have an access device which is set up to access the second database table and to ascertain data which are contained in the second database table's data records selected in line with the second selection, and where the processing device is set up to ascertain the result of the analysis query using the data.

Illustratively, if the second database image does not have sufficient information to answer the analysis query, the underlying second database table is used. It is not necessary to access the entire second database table, however, but only the data records selected in line with the second selection.

This is advantageous particularly if only a small portion of the data records meets the selection criteria for the second selection and therefore only a few data records need to be retrieved from the second database table, since access to the second database table is much slower than access to the second database image, since the second database table's memory requirement means that it typically needs to be stored in a memory which allows much slower access than the memory storing the second database image.

Illustratively, the second database image is used as a multidimensional index for the second database table. This is explained more precisely further below.

It is also possible for the first database image to group the first multiplicity of data records to form a first plurality of segments (clusters) and/or for the second database image to group the second multiplicity of data records to form a second plurality of segments.

Illustratively, the first database image and/or the second database image are produced in line with a statistical clustering model.

For example, the value of the database key for a data record in the first database image (that is to say for a data record in the first multiplicity of data records) comprises a number for the segment which contains the data record and a number for the data record in line with numbering of the data records in the segment.

For example, the value of the database key for a data record in the second database image (that is to say for a data record in a second multiplicity of data records) comprises a number for the segment which contains the data record and a number for the data record in line with numbering of the data records in the segment.

As an example, the database key used is a “natural key”, which is obtained naturally from the classification into clusters, with the data records being consecutively numbered within the cluster.

As an example, the “natural key” is used instead of a database key, which is used in the first database table or in the second database table (for example a customer number), to link the first database image and the second database image.

It is also possible for each data record in the first multiplicity of data records to have the value of the database key stored for it in the first database table and/or for each data record in the second multiplicity of data records to have the value of the database key stored for it in the second database table.

This is of particular importance when the “natural key” described above is used for the data records. In this case, the “natural key” is used to link the first database image and the second database image. If recourse is had to the first database table or to the second database table, for example within the context of the aforementioned use as a multidimensional index, the value of the “natural key” is associated with the value of the database key which is used in the first database table (for example transaction number) or in the second database table (for example customer number), which is made possible by virtue of each data record having the value of the “natural key” stored for it in the first database table or in the second database table.

Independently of the above database query system or as an alternative to the above database query system, one embodiment provides a method for producing a compressed image of a database table which contains a multiplicity of data records, where each data record contains a value for at least one statistical variable, having the following steps:
a statistical probability model for describing the relative frequencies of the values of the at least one statistical variable in the data records in the database table and for grouping the data records to produce a respective segment for a plurality of segments is ascertained;
for each segment in the plurality of segments, according to the relative frequencies of the values of the at least one statistical variable in the data records in the segment, a representative value for the at least one statistical variable is ascertained;
for each segment in the plurality of segments, a first encoding value is allocated to the representative value of the respective segment;
for each data record, a second encoding value is allocated to the data record's included value of the statistical variable if the value which the data record contains differs from the representative value of the segment which contains the data record.

In addition, an arrangement, a computer-readable storage medium and a computer program element are provided in line with the above-described method for producing a compressed image of a database table.

As an example, the allocation of the first encoding value to the representative value and the allocation of the second encoding value to the data record's included value of the statistical variable can be compression of the representative value or of the data record's included value of the statistical variable. For example, the second encoding value is stored.

Illustratively, a database table is divided into a multiplicity of segments. For each segment and for each statistical variable, for which each data record contained in the segment contains a value, a representative value, as an example a default value, for the statistical variable is determined. The representative value is a value of the statistical variable which occurs with high relative frequency within the segment, that is to say in the case of the data records which the segment contains. For each data record which the segment contains, it is now assumed that the value which corresponds to the representative value is contained in the data record and accordingly the value which the data record contains is encoded only if the form differs from the representative value.

Illustratively, the value of a random variable is explicitly stored/encoded only if this value differs from the value which would be expected on the basis of statistical modeling (i.e. from the representative value). In the simplest case, the expected value is the most frequent value in a database table or in the segment of a database table. For a higher level of compression, the expected value (default value) chosen may also be the value which is the most probable value on the basis of the forecast by a statistical model.

It is possible for the representative value to be determined on the basis of the description, provided by the statistical probability model, of the relative frequencies of the values of the at least one statistical variable in the data records in the segment.

Illustratively, the statistical probability model is thus used to determine what value is suitable as a representative value for the statistical variable in the segment.

In this way, the representative value can be determined with little computation complexity.

By way of example, the value for which the statistical probability model indicates a high relative frequency within the segment is chosen as representative value.

For example, the representative value corresponds to a value of the statistical variable which occurs in the data records contained in the segment with a relative frequency which is above a prescribed threshold value.

In one embodiment, the value of the statistical variable which occurs with the highest relative frequency within the segment is chosen as the representative value, for example.

In this case, only very few values need to be encoded, since most data records which the segment contains have the representative value as a value of the statistical variable. It is thus possible to obtain a high level of compression.

For example, the statistical probability model is a graphical probability model. By way of example, a Bayesian network is used as the probability model.

It is possible for the values of the statistical variable which are contained in data records which the same segment contains and which (values) differ from the representative value of the segment to be encoded using a method for arithmetic encoding and/or a method for run length encoding.

Illustratively, in one embodiment the data records are efficiently encoded by grouping the data records to produce segments of similar data records, are stored in a data structure constructed in line with these segments, and the similarity of the data records within the segments is utilized for the purpose of more efficient encoding by statistical methods (e.g. run length encoding, arithmetic encoding).

In this case, the data in each segment can be stored in rows (i.e. all the values of the same data record are stored in the memory next to one another, that is to say at adjacent memory locations). Alternatively, the data can be stored in columns (i.e. in fields; values in the first field of all the data records are located directly next to one another in the memory).

In addition, independently of the above database query system or as an alternative to the above database query system, one embodiment provides a computer arrangement for analyzing data, having
a display device which is set up to display at least one first window, which has a first display element which comprises the display of a descriptor for a first analysis result relating to a first statistical quantity and/or the display of the first analysis result, and a second window, which has a second display element which comprises the display of a descriptor for a second analysis result relating to a second statistical quantity and/or the display of the second analysis result;
a selection device which a user can use to select the first display element and to move it to the location of the second display element;
a detection device which is set up to detect whether the first display element has been moved to the location of the second display element;
a calculation device which is set up to calculate a third analysis result relating to the first statistical quantity and to the second statistical quantity if the first display element has been moved to the location of the second display element;
the display device being set up to display the third analysis result.

Illustratively, a user can use drag & drop on a graphical user interface to move the first display element toward the second display element and thereby control the computer arrangement such that the third analysis result is determined.

A display element which is the display of a descriptor for a first analysis result relating to a statistical quantity and/or the display of the analysis result is, by way of example,
a descriptor field in a window on a screen interface, where the window contains the relative frequencies of the forms of a statistical variable which occur in a database table;
the display, for example the displayed value, of a relative frequency for a form of a statistical variable which occurs in a database table or the display of another analysis result;
the descriptor of a value of a statistical variable or the descriptor of a group of forms of a statistical variable;
the descriptor of a statistical variable or the descriptor of a group of statistical variables.

Illustratively, an improved usability concept, particularly for the operator control of computer programs which allow querying of databases and the statistical analysis of data stored in a database, is provided.

It is possible for the first analysis result to be based on data contained in a first database table and for the second analysis result to be based on data contained in a second database table.

Illustratively, the first window is therefore used to analyze the first database table and the second window is used to analyze the second database table. The user can thus cross windows to produce analysis results which are based particularly on data contained in the first database table and on data contained in the second database table.

By way of example, the first database table is a transaction database table which contains data about transactions performed in a construction market, and the second database is a customer database table which contains data about the customers in the construction market. A user can use a first window to display the distribution of the random variable “total sales for the customers” (relative frequency of the total sales for the customers) as a first analysis result. The first window thus uses a table, for example, to indicate that 30% of the customers in the construction market performed transactions to achieve total sales of between 100 euros and 150 euros in 2004 (and accordingly further values for other value ranges of the total sales). By way of example, the first table bears the title “Total sales for the customers”. A second window is used to display a second analysis result relating to the transaction database, for example a second table entitled “products” shows the relative frequency of the products purchased. By way of example, the second table contains the entry that 3% of all transactions involve the purchase of bedding and balcony plants, 7% of all transactions involved the purchase of garden furniture etc.

The user can now have the customer broken down over the products, for example, that is to say can produce and display an analysis result which contains the information that 25% of the customers made up total sales of between 100 euros and 150 euros in purchases of bedding and balcony plants (and accordingly further values for other value ranges of the total sales and for other products), for example. The user achieves this, by way of example, by selecting the title bar of the first window, for example a field with the character string “total sales for the customers”, and moving it to the second window, for example drags it to the second window using drag & drop.

The display device is for example a computer screen.

The selection device is for example a computer mouse.

Alternatively, the display device used may be a touch screen, for example, and the user can select and move the first display element by touching the touch screen. Accordingly, the selection device is an element of the touch screen.

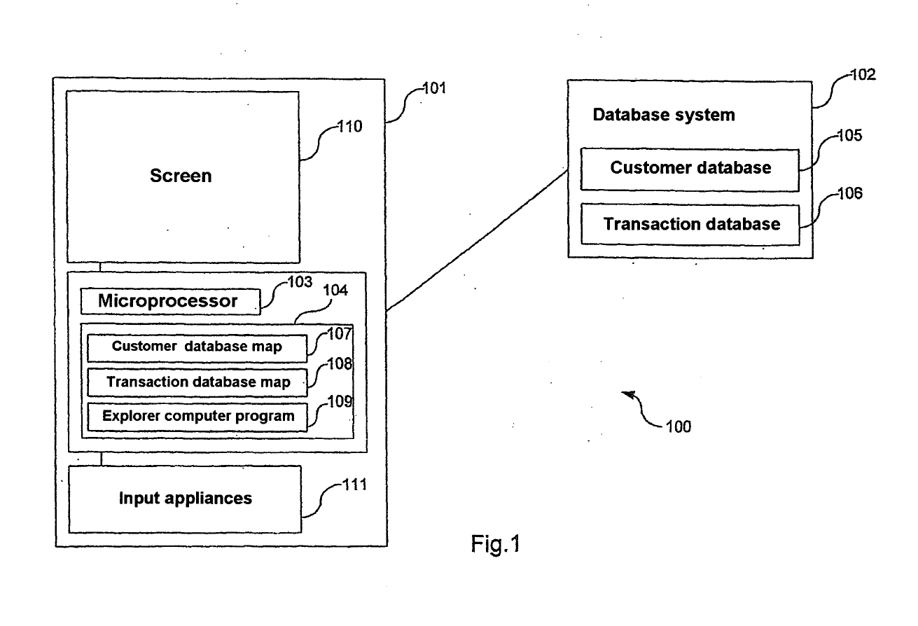

FIG. 1 shows a computer arrangement 100 based on an exemplary embodiment of the invention.

A computer system 101 is coupled to a database system 102.

The computer system 101 is a personal computer (PC) in this exemplary embodiment, but may also be another computer, for example a workstation.

The computer system 101 has a screen 110, a microprocessor 103, a memory 104 and various input appliances 111, for example a keyboard and a computer mouse.

The database system 102 is a computer system for storing database tables. The database system 102 may accordingly be a computer which is equipped with a large storage capacity and which is coupled to the computer system 101, for example by means of an Ethernet interface or wirelessly, for example by means of Bluetooth. The database system may operate in the manner of an Oracle database, a Microsoft Access database, a Lotus 1-2-3 database or a dBase database, for example.

The database system 102 stores a customer database table 105 and a transaction database table 106, which are described more precisely further below.

The memory 104 of the computer system 101 stores a customer database table image 107, that is to say a compressed image of the customer database table 105, and a transaction database table image 108, that is to say a compressed image of the transaction database table 106. As an example, the customer database table image 107 and the transaction database table image 108 are data structures which contain the data from the customer database table 105 and from the transaction database table 106 in compressed form.

The type of compression and the structure of the customer database table image 107 and of the transaction database table image 108 are described in detail further below.

In another embodiment, the database system 102 is part of the computer system 101. By way of example, the computer system 101 has a hard disk which stores the customer database table 105 and the transaction database table 106, and also has a main memory which stores the customer database table image 107 and the transaction database table image 108, so that it is possible to access particularly the customer database table image 107 and the transaction database table image 108 quickly.

The memory 104 also stores an explorer computer program 109 which is executed by the microprocessor 103 and which allows it to graphically display results of a statistical analysis of the customer database table image 107 (and hence of the customer database table 105) and of the transaction database table image 108 (and hence of the transaction database table 106) on the screen 110.

This is explained more precisely below.

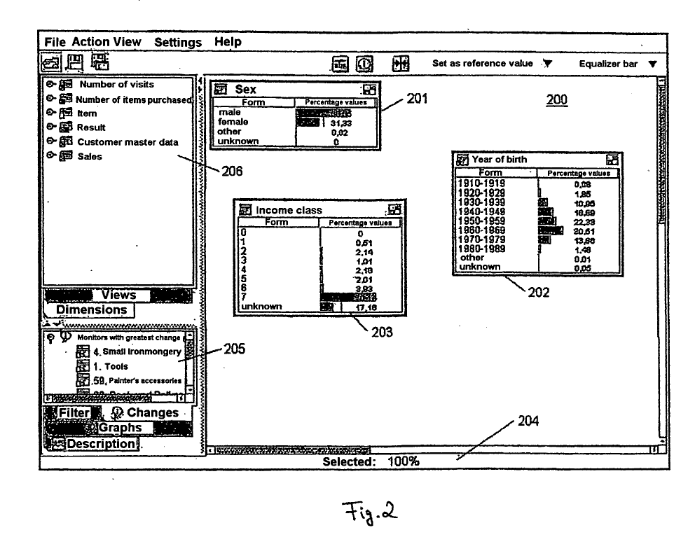

FIG. 2 shows a first screen display 200 for an explorer computer program based on an exemplary embodiment of the invention.

The first screen display 200 shows results of a statistical analysis of the customer database table image 107 and hence results of a statistical analysis of the customer database table 105.

The customer database table 105 contains information about the customers in a construction market. Thus, the customer database table contains, for each customer in the construction market (or for each registered customer in the construction market), a customer data record which contains a customer number for the customer, the sex of the customer, the class of income for the customer and the customer's year of birth. The customer data records which the customer database table 105 contains may also contain a multiplicity of further information items about the respective customer, but in this example it is assumed that they contain only the information stated above.

The customer database table image 107 accordingly contains this information about the customers in the construction market in compressed form, as explained further below.

The explorer computer program 109 allows analysis of the data contained in the customer database table image 107 and graphical display of results from such analysis.

In this exemplary embodiment, the explorer computer program 109 has been used to examine the nature of the age distribution for the customers in the construction market and to show the result from the explorer computer program 109 in a first window 201 of the first screen display 200.

From this, it can be seen that 68.65% of the construction market customers are male and that 31.33% of the construction market customers are female.

As an example, the explorer computer program 109 performs this analysis by counting all the customer data records which contain the information that the customer corresponding to the customer data record is male and counting all the customer data records which contain the information that the relevant customer is female, and relating the results of the count to the total number of customer data records.

In addition, the explorer computer program 109 has been used to analyze the age distribution for the customers in the construction market by counting customer data records which contain the information that the relevant customer's year of birth is in a particular range.

The result of this analysis of the age distribution is displayed in a second window 202 of the first screen display 200 on the screen 110.

In addition, the explorer computer program 109 has been used to examine the nature of the distribution of the classes of income for the construction market customers, and to display the result of this analysis in a third window 203 of the first screen display 200. It can be seen that most of the construction market customers (70.14%) are in the income class 7.

The analyzes whose results are displayed in the first window 201, in the second window 202 and in the third window 203 are based on all the customer data records, for example all the customer data records have been counted which contain the information that the relevant customer is male and have been related to the number of all the customer data records in order to ascertain the relevant analysis result (68.65%).

Since all the customer data records have formed the basis for the analyzes, a selection information field 204 is used to display the value 100%. In another embodiment, the selection information field 204 also contains the total number of customer data records which have formed the basis for the analyzes.

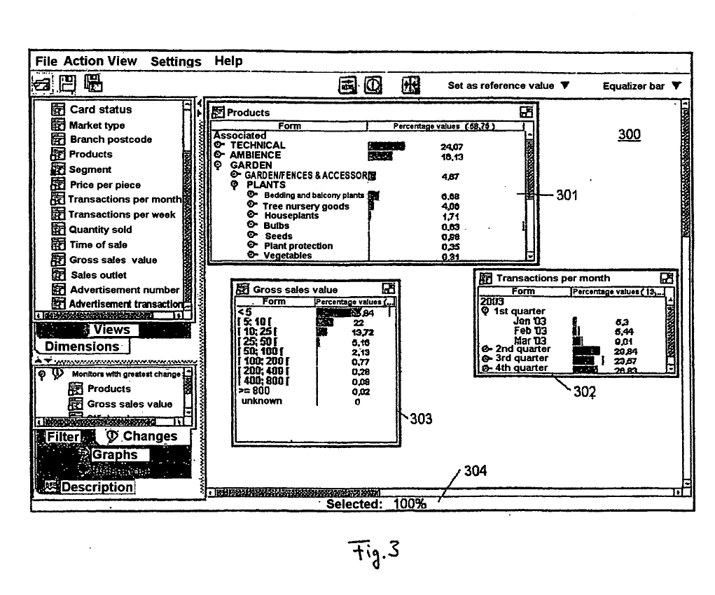

The first screen display 200 has, like all the other screen displays shown in FIG. 3 to FIG. 7, a first selection window 205 and a second selection window 206. The first selection window 205 and the second selection window 206 allow the user to set further windows to be displayed in the area next to the first selection window 205 and the second selection window 206, for example windows with analysis results similar to the first window 201, the second window 202 and the third window 203 which relate to other statistical variables, for example the sales for the customers in the construction market.

The explorer computer program 109 can, as mentioned, also be used to analyze the transaction database table image 108 and hence the transaction database table 106. The analysis results can likewise be displayed on the screen 110, and FIG. 3 shows a corresponding display.

FIG. 3 shows a second screen display 300 for an explorer computer program based on an exemplary embodiment of the invention.

It is possible to change to and from between the first screen display 200 and the second screen display 300 by operating (clicking on) an icon in a toolbar, for example.

In this exemplary embodiment, the transaction database table 106 contains a multiplicity of transaction data records. Each transaction data record corresponds to a transaction, that is to say to a sales operation, in the construction market and contains a transaction number which explicitly identifies the transaction, a specification for the product sold in the course of the transaction, the statement indicating the gross sales value for the transaction, the date of the transaction and the customer number of the customer who was involved in the transaction, that is to say who purchased the product which was sold. This information is contained accordingly in the transaction database table image 108 in compressed form.

The second screen display 300 uses a first window 301 to show the results of an analysis of how often certain products have been purchased by customers in the transactions in the construction market as a ratio of all the transactions in the construction market.

By way of example, technical products have been purchased in 24.07% of all transactions in the construction market. The groups of products, such as “Technical”, “Ambience” and “Garden”, are classified more precisely, for example the product group “Garden” has the subgroup “Garden/fences and accessories” and the subgroup “Plants”. The subgroup “Plants” is also divided into “Bedding and balcony plants”, “Tree nursery goods”, “Indoor plants” etc.

It can be seen from the first window that bedding and balcony plants have been sold in 6.68% of all transactions in the construction market.

This analysis result is attained by counting all the transaction data records which contain the information that bedding and balcony plants have been sold in a relevant transaction. The result of the count is related to the total number of transaction data items, which gives the percentage value (6.68%).

A second window 302 is used to display the result of an analysis of how the number of transactions is distributed over the year.

It is thus possible to tell, for example, that 9.01% of all transactions have been performed in March. This result is ascertained by determining the number of transaction data records which contain the information that the relevant transaction was performed on a day in March, which can be determined by evaluating the date of the transaction, and relating the number to the total number of transaction data records.

A third window shows the result of an analysis of the distribution of the gross sales value over the transactions. By way of example, it is possible to see that for 13.72% of all transactions the gross sales value was between 10 euros and 25 euros.

The analyzes whose results are displayed in the first window 301, in the second window 302 and in the third window 303 form the basis of all transaction data records, which is why, in similar fashion to FIG. 2, the value 100% is displayed in a selection information field 304. The text below explains an example in which an analysis forms the basis of only a portion of the transaction data records.

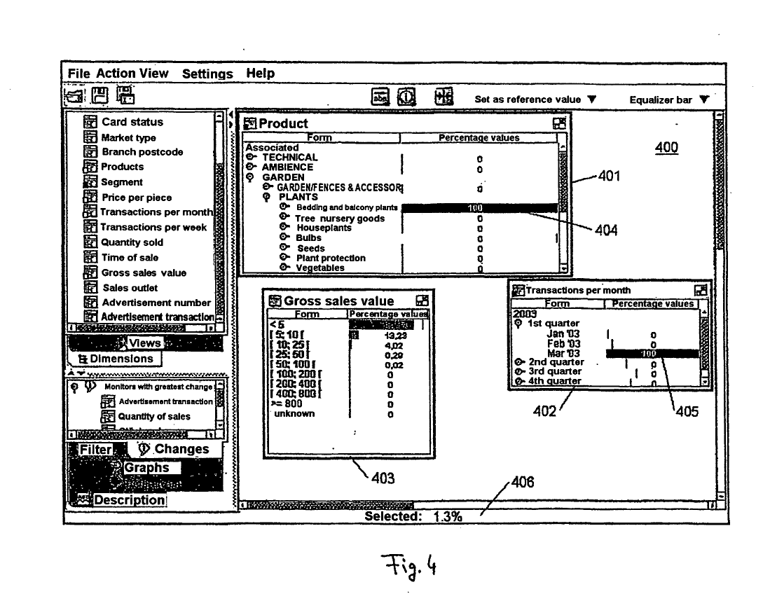

FIG. 4 shows a third screen display 400 for an explorer computer program based on an exemplary embodiment of the invention.

The third screen display 400 comes from the second screen display 300 when a user uses one of the input appliances 111 to select bedding and balcony plants in the first window 301 of the second screen display, which corresponds to a first window of 401, and to select March 2003 in the second window 302 of the second screen display 300, which corresponds to a second window 402.

By way of example, the user uses a computer mouse to click on the value 6.68 in the first window 301 of the second screen display 300, which replaces this value with a first bar 404 and the value 100, as shown in the first window 401. Similarly, it is assumed that the user has used a computer mouse to click on the value 9.01 in the second window 302 of the second screen display 300, for example, which replaces this value with a second bar 405 and the value 100, as shown in the second window 402.

The first bar 404 indicates that now only transaction data records which contain the information that a bedding and balcony plant has been sold in the relevant transaction are selected.

The second bar 405, which, like the first bar 404, is displayed in a conspicuous color, for example red, indicates that only transaction data records which contain the information that the relevant transaction was performed in March 2003 are selected.

Hence, as a whole, all the transaction data records which contain the information that the relevant transactions were performed in March 2003 and that a bedding and balcony plant was sold in the course of the transaction are selected.

Accordingly, only a fraction of the total number of transaction data records is selected. In this example, 1.3% of all the transaction data records correspond to transactions in which a bedding and balcony plant was sold in March. This is shown in a selection information field 406, which corresponds to the selection information field 304 in the second screen display 300.

The selected data records are taken as a basis for the analyzes whose results are displayed in the first window 401, in the second window 402 and in the third window 403.

Since all the selected transaction data records contain the information that a bedding and balcony plant was sold in the respective transaction, 100% of all the selected transactions, that is to say transactions corresponding to the selected transaction data records, involved the sale of bedding and balcony plants, which is indicated by the value 100 in the first bar 404.

Similarly, in line with the selection of the transaction data records, 100% of all the selected transactions were performed in March 2003, which is shown by the number 100 in the second bar 405.

By contrast, a nontrivial analysis result is shown in the third window 403.

By way of example, it is possible to see that the gross sales value is below 5 euros for 82.45% of all the selected transactions. That is to say that for all the transactions which took place in March 2003 and during which a bedding and balcony plant was sold, the gross sales value was below 5 euros.

It will now be assumed that a sales manager in the construction market would like to analyze the age distribution of those customers who purchased at least one bedding and balcony plant in March 2003. The sales manager might want to perform this analysis in order to ascertain whether it is worth starting a “Geraniums for pensioners” discount sale next March.

To this end, the sales manager starts the explorer computer program 109 on the basis of the customer database table image 107, so that the first screen display 200 is displayed on the screen 110.

Next, he starts a new instance of the explorer computer program 109 (or opens another window in the explorer computer program 109) on the basis of the transaction database table image 108, so that the second screen display 300 is displayed on the screen 110.

Next, the sales manger selects bedding and balcony plants in the first window 301 of the second screen display 300 and also March 2003 in the second window 302 of the second screen display 300, as described above with reference to FIG. 4, so that the second screen display 300 changes to the third screen display 400.

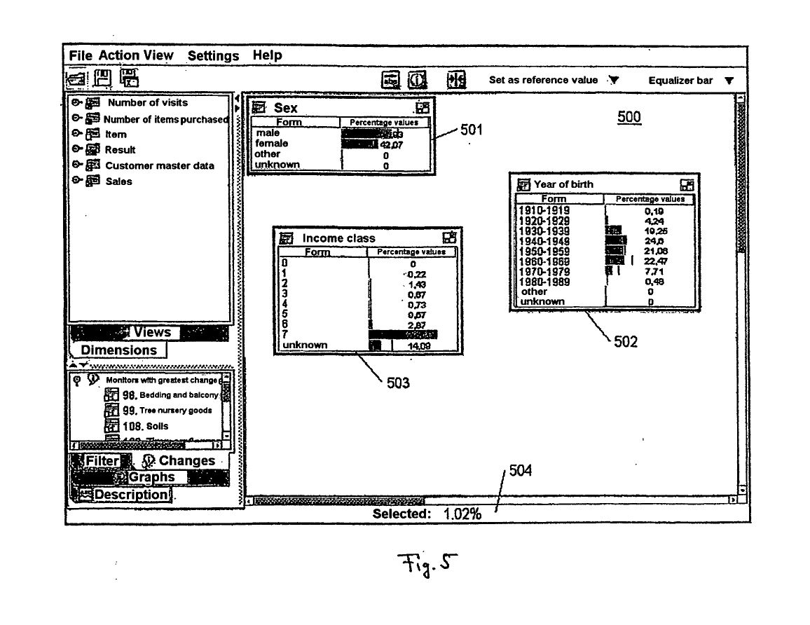

The sales manager then clicks on an appropriate icon, for example, to change to the first screen display 200, which, in line with the selection, has changed to the fourth screen display 500, however, which is shown in FIG. 5.

FIG. 5 shows a fourth screen display 500 for an explorer computer program based on an exemplary embodiment of the invention.

In line with the selection of all the transactions which have been performed in March 2003 and for which a bedding and balcony plant has been sold, the analyzes whose results are shown in a first window 501, corresponding to the first window 201 in the first screen display 200, in a second window 502, corresponding to the second window 202 in the first screen display 200, or in a third window 503, corresponding to the third window 203 in the first screen display 200, are based on precisely the customer data records which correspond to customers who have purchased a bedding and balcony plant in March 2003.

This is done by determining all those customer numbers in the transaction database table image 108 which respectively correspond to a transaction data record which is based on a transaction which was performed in March 2003 and in the course of which a customer (namely the customer specified by the customer number) purchased a bedding and balcony plant). The analyzes whose results are displayed in the first window 501, in the second window 502 or in the third window 503 are now based on precisely the customer data records which contain one of the customer numbers determined in this manner. These customer data records are subsequently referred to as the selected customer data records.

Illustratively, the customer number is used as a database key which links associated customer data records and transaction data records to one another.

In line with the selection of the customer data records, a selection information field 504 corresponding to the selection information field 204 in the first screen display 200 is used to display the proportion of the selected customer data records in the total number of customer data records, in this example 1.02%. That is to say that 1.02% of the (registered) customers in the construction market have purchased at least one bedding and balcony plant in March 2003.

The selected customer data records are taken as a basis for the analyzes whose results are displayed in the first window 501, in the second window 502 and in the third window 503.

By way of example, it is possible to see from the first window 501 that 57.93% of all customers who purchased at least one bedding and balcony plant in March 2003 are male.

From the third window 503, it is possible to see that 79.41% of the selected customers, that is to say of the customers corresponding to the selected customer data records, belong to income class 7.

In this example, however, the sales manager is interested in the result of the analysis whose result is displayed in the second window 502.

It can be seen that 19.25% of all customers who purchased at least one bedding and balcony plant in March 2003 were born between 1930 and 1939.

Through comparison with the second window 202 in the first screen display 100, it can be seen that the proportion of the customers born between 1930 and 1939 who purchased at least one bedding and balcony plant in March 2003 in all customers who purchased at least one bedding and balcony plant in March 2003 is greater (19.25%) than the proportion of the construction market's customers born between 1930 and 1939 in all the construction market's customers (10.95%).

From this, the sales manager could conclude that it might be worth starting a “Geraniums for pensioners” discount sale next March.

Illustratively, the data in the exemplary embodiment described above are not available in the form of what is known as a flat data structure, that is to say in a single database table, but rather are distributed over a plurality of database tables, in this example the customer database table 105 and the transaction database table 106. The customer database table 105 and the transaction database table 106 are in a 1:n ratio through the customer number, since in this example a customer may be involved in a plurality of transactions. In other embodiments, m:n ratios are also conceivable, for example when a customer may be involved in a plurality of transactions, and a plurality of customers can perform a transaction together.

In one embodiment, when a selection has been made as shown in FIG. 4, the first screen display 200 displays a further window which the user can use to select whether the selection shown in FIG. 4 is intended to be taken as a basis for the analyzes whose results are shown in the first window 201, in the second window 202 and in the third window 203. By way of example, the further window can be put into the state “Yes”, which means that the selection shown in FIG. 4 is taken as a basis for the analyzes. This state may also be denoted in the further window (instead of by “Yes”) by “Customer has performed transactions corresponding to the selection in the other database table” or “customer has performed transactions with product=bedding plants, gross sales value<5, transaction month=March 03”, for example. Accordingly, the further window can have a state “No” (or correspondingly denoted state). The user, in this example the sales manager, can use a computer mouse, for example, to put the further window into one of the two states, i.e. to select one of the two states and thereby determine whether the currently entered selections in the other database table are intended to be taken into account in the evaluation of this database table.

The further window can either keep its name and the effect of selections made therein when the selection is altered in the second screen display, or can automatically adapt them. Accordingly, the first screen display will therefore either continue to relate to bedding plants (for example if the mode “retain” is activated) or will change to drilling machines if the selection in the second display is changed from bedding plants to drilling machines.

In addition (and assuming that “yes” has been selected in the further window described above, i.e. the selection shown in FIG. 4 has been adopted), the fourth screen display 500 can be used in similar fashion to the third screen display 400 to make a fresh selection, in this case of customers. In line with this selection, the common key (customer number) for the transaction database table image 108 and for the customer database table image 107 can be used to select transactions which are taken as a basis for the analyzes whose results are shown in the third screen display. By way of example, the user could select those customers in the fourth screen display 500 who purchased at least a bedding and balcony plant in March 2003 and who belong to income class 6, for example by clicking on the value 2.87 in the third window 503.

If the mode of the further windows is set to “retain”, the selection of customers which was described in the last paragraph and determined by the interaction of the transaction table and the customer table can be transferred back to the transaction environment, so that it is possible to learn more about the other transactions for this customer group than the previously defined bedding and balcony plants in March. To this end, first of all the selections in the third screen display are removed again (which, in line with the “retain” mode, has no effects on the fourth screen display 400) and the state “yes” is selected in the further window displayed there, which transfers the customer list which is currently active in the fourth screen display 400 to the third screen display 300. Accordingly, the third screen display 300 would be altered and the third window 403 would now display the distribution of the gross sales values of the transactions which are performed by customers who belong to income class six and who purchased at least one bedding and balcony plant in March 2003.

The selection can now be continued. In this way, it is possible to answer complicated questions, such as the question “what do customers who have purchased garden fences in May purchase in September?”. This can be utilized strategically by a sales manager, for example to decide whether paints for garden fences need to be provided in Autumn if a particularly large number of garden fences have been sold in Spring in a year.

In the exemplary embodiment described above, two database images are combined which show different views. Thus, the customer database table image 107 corresponds to a view of the customers in the construction market and the transaction database table image 108 corresponds to a view of the transactions which have been performed in the construction market.

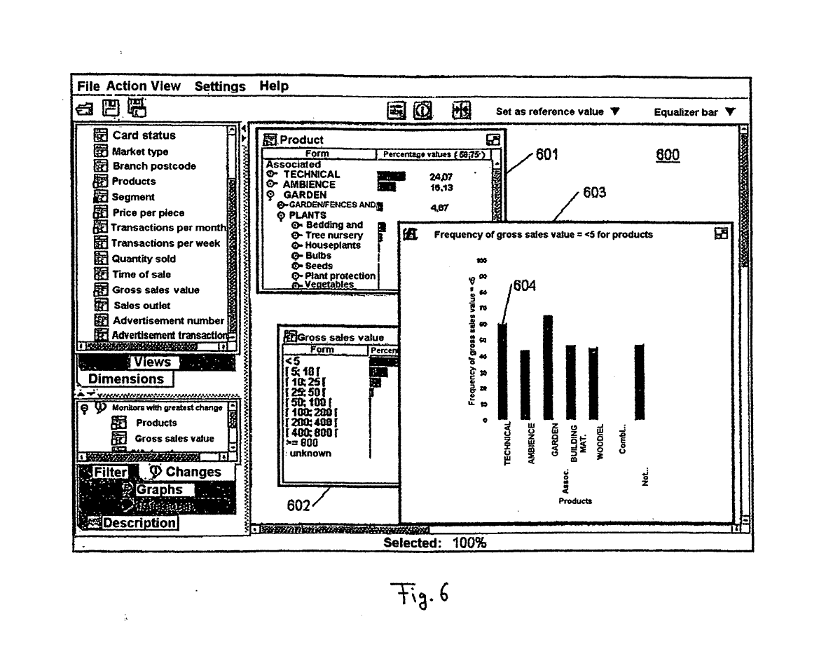

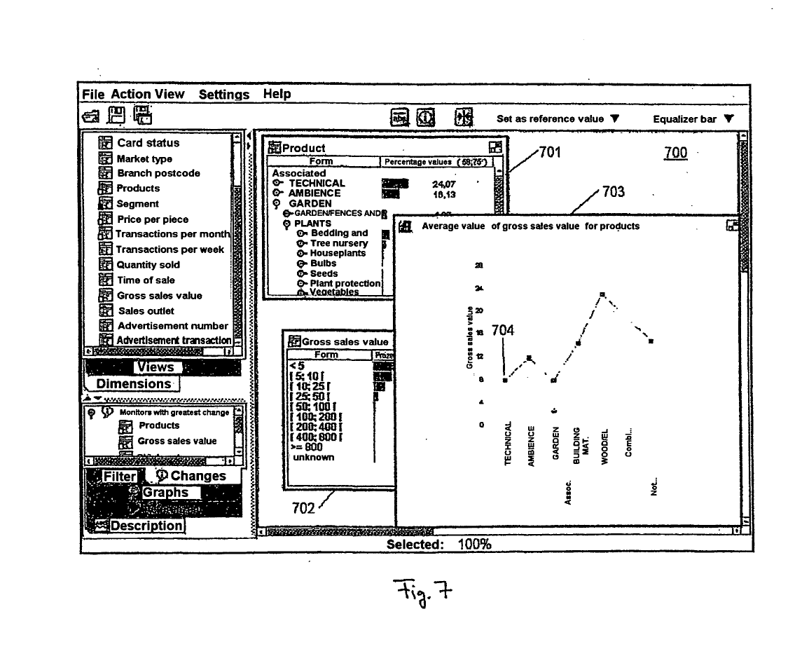

The text below refers to FIG. 6 and FIG. 7 to explain further screen displays showing results of analyzes which have been performed by the explorer computer program 109.

FIG. 6 shows a fifth screen display 600 for an explorer computer program based on an exemplary embodiment of the invention.

The fifth screen display 600 comes from the third screen display 400.

The fifth screen display 600 contains (in part) a first window 601 which corresponds to the first window 301 in the second screen display 300. The fifth screen display 600 also contains (in part) a second window 602 which corresponds to the third window 303 in the second screen display 300.

A third window 603 shows the result of an analysis in which it has been respectively determined for various product groups what the proportion of the transactions is in which a product from the respective product group has been sold and in which the gross sales value was below 5 euros in all transactions in which a product from the respective product group has been sold.

By way of example, a first bar 604 is used to show that for approximately 60% of all transactions in which a product from the product group “Technical” was sold the gross sales value was below 5 euros. Corresponding bars are shown for the product groups “Ambience”, “Garden”, “Building materials/sanitation” etc.

Illustratively, the value “below 5 euros” for the random variable “gross sales value” is broken down over the product groups.

The user of the explorer computer program 109 can produce the fifth screen display 600 from the third screen display 400 by clicking on the value (65.84) for the form “<5” in the third window 403 of the third screen display 400 with a computer mouse, keeping the mouse key depressed and dragging the value to the first window 401 of the third screen display 400 (drag and drop).

In general, it is possible to break down a value for a first random variable over a second random variable by dragging the value for the relative frequency of the form of the first random variable to a window showing the relative frequencies of the forms of the second random variable by means of drag and drop. This can also be done using a screen display. By way of example, the user can click on the value (65.84) for the form “<5” in the third window 403 of the third screen display 400 using a computer mouse, can use an appropriate command to change to the fifth screen display 500 and can drag said value to the first window 501. Accordingly, the form “below 5 euros” of the random variable “gross sales value” would be broken down over the sexes and, by way of example, a bar would be displayed showing that for 40% of all transactions performed by a male customer the selling price was below 5 euros (and a further bar accordingly for the female customers).

In this example, the first random variable is the gross sales value and the second random variable is the product. In another embodiment, it is also possible to produce a three-dimensional graphical representation in similar fashion, for example likewise using drag and drop. By way of example, a graphical three-dimensional representation could be produced in which all product groups are shown along one axis (that is to say values of a first random variable), as is also the case in the third window 603, ranges of gross sales values, for example “<5”, “5-10”, are shown along a second coordinate axis (values of a second random variable), etc. At a point on the grid formed by the first coordinate axis and the second coordinate axis, corresponding to a particular product group and to a particular gross sales value range, it would be possible to use a bar in the direction of a third coordinate axis to show the proportion of the transactions in which a product from the product group has been sold and in which the sales value is within the sales value range in the transactions in which a product from the product group has been sold.

Illustratively, this corresponds to the representation of the analysis result shown in the third window 603 for all gross sales value ranges (not just for the gross sales value range “<5”) by virtue of the representation shown in the third window being extended by a further coordinate axis (the aforementioned second coordinate axis) and accordingly a two-dimensional scheme of bars being produced.

FIG. 7 shows a sixth screen display 700 for an explorer computer program based on an exemplary embodiment of the invention.

The sixth screen display 700 has (in part) a first window 701 which corresponds to the first window 301 in the second screen display 300.

The sixth screen display 700 also has (in part) a second window 702 which corresponds to the third window 303 in the second screen display 300.

A third window 703 shows the result of a further analysis. The analysis involved determining the average gross sales value for all transaction data records which correspond to a transaction in which a product from a particular product group has been sold, and doing this accordingly for a plurality of product groups.

By way of example, a marker 704 shows that the average gross sales value for all gross sales values for transactions in which a product from the product group Technical has been sold is approximately 8 euros. Appropriate further markers indicating respective average gross sales values for various product groups are likewise shown in the third window 703, in this example for the product groups “Ambience”, “Garden”, “Building materials/sanitation” etc.

Illustratively, the average gross sales value (for the gross sales values from all transaction data records) is broken down over the various product groups.

The user can produce the sixth screen display 700 from the second screen display 300 by dragging the field containing the character string “percentage value” from the third window 303 to the first window 301 using drag & drop, for example. In this case, the user could be shown a selection menu which the user can use to select from a plurality of options.

By way of example, the user can select that instead of the third window 703 a window is displayed which does not indicate the average gross sales value for each product group but rather the total value of all gross sales values which are contained in transaction data records corresponding to transactions in which a respective product from the respective product group has been sold. By way of example, in this case a further marker (similar to the marker 704) could be displayed which indicates the sum of all sales values from transaction data records which correspond to transactions in which a product from the product group “Technical” has been sold.

Illustratively, the total sales are thus broken down over various product groups.

For the analyzes whose results are shown in the third window 603 of the fifth screen display 600 or in the third window of the sixth display 700, it has been assumed that all the transaction data records have always been taken as a basis. However, it is also possible to base the analyzes only on a portion of the transaction data records by selecting particular transaction data records, as explained above with reference to FIG. 4 and FIG. 5.

In similar fashion to the breakdown of the average value over various product groups as shown in FIG. 7, it is also possible to break down other statistical quantities over forms of random variables. By way of example, for each product group it will be possible to determine the variance in the gross sales values for all transactions in which a product from the respective product group has been sold.

In another embodiment, all analyzes may also be based on weighted data records. By way of example, a customer data record is weighted with what sales have previously been made to the relevant customer. Thus, by way of example, a higher proportion of customers would be obtained for a first age range than for a second age range, in line with the display of the second window 202 in the first screen display, if the customers in the first age range have accounted for more sales than the customers in the second age range, even though the number of customers in the first age range is not greater than the number of customers in the second age range (since the weighting is taken into account when counting the relevant customer data records). This presupposes that each customer data record contains information about the sales for the respective customer.

Similarly, transactions can be weighted according to their proportion of sales in the case of analyzes which relate to the transaction database table 106.

When customers are selected, as explained above with reference to FIG. 4, for example, the screen display relating to the customer database table 105 can be used to display a window in which the selected customers are broken down according to the form of a random variable.

In line with the example above, in which all customers who purchased a bedding and balcony plant in March 2003 are selected, the fourth screen display 500 could be used to show a further window which shows (for example by means of bars) for various sales ranges the proportion of the customers who accounted for the respective sales and purchased a bedding and balcony plant in March in all the customers who purchased bedding and balcony plants in March.

The text below explains the form and structure of a database image of a database table based on an exemplary embodiment of the invention, for example the customer database table image 107.

The database table has a plurality of data records which, when written beneath one another as an example, form the database table. By way of example, each (registered) customer in a construction market has a data record as in the example described above. Each data record has a database table entry, for example, which contains the age of the respective customer. Illustratively, the data records form rows in which the age of the customer corresponding to the respective row is indicated in an “Age” column.

The attribute ‘age’ (and other attributes which exist, such as income, sex etc.) of the customer is interpreted, that is to say regarded, as a random variable. Depending on the customer, this random variable assumes a particular value (state, form), for example the value 23 if the relevant customer is 23 years old. The possible values of the random variables occur with a relative frequency in the database table. If a quarter of all (registered) customers in the construction market are 23, for example, then the relative frequency of the value (state) 23 of the random variable ‘age’ is 0.25 or 25%.

To produce the database image of the database table, a statistical model of the data in the database table is produced. As an example, the statistical model is an approximation of the common probability distribution of the random variables in the database table.

In the example above, in the course of production of a statistical model of the database table, it is determined, by way of example, that the probability of a customer being 23 is 0.25, which can be written formally in the following manner:

### P (customer is 23)=0.25

The statistical model is “learnt” through a learning process using the entries in the database table, that is to say is produced using the entries in the database table, for example using a maximum likelihood approach. The probabilities which exist within the context of the statistical model of the database table describe, as mentioned, the relative frequencies of the states of the database table entries, exactly or approximately, depending on the procedure. The database table entries may assume a multiplicity of states, which states may arise with different relative frequencies.

As soon as a statistical model has been produced, this can be used to study the relative dependencies between the states of the random variables, that is to say the correlation of the random variables.

Thus, by way of example, the relative frequencies (probabilities) of the states of particular random variables can be prescribed on the basis of a prescribable condition, and the relative frequencies of the states, corresponding to the prescribable frequencies of the states of the random variables, of further random variables which are dependent thereon (correlated thereto) can be ascertained.

The statistical model used is a graphical probability model (Graphical Probabilistic Model), for example, as described in [1], for example. The graphical probability models include, in particular, Bayesian networks (or Belief networks) and Markov networks.

A statistical model can be produced by structure learning in Bayesian networks, for example, as described in [2], for example.

Another option is to learn, that is to say to determine, the parameters of the statistical model for a fixed structure, as described in [3], for example.

Within the context of a large number of learning methods, a likelihood function is used as an optimization criterion for the parameters of the model. In this context, one particular version is the Expectation Maximization (EM) learning method, which is described in more detail below with reference to a specific model.

Typically, a high level of generalization capability in the statistical model is not important, but rather good adaptation of the statistical model to suit the data contained in the database table, that is to say a good match between the random variables' probabilities specified by the statistical model and the relative frequencies provided by the database table entries.

The statistical model used is for example a statistical clustering model, particularly a Bayesian clustering model, which divides the data into a plurality of clusters (also called segments).

The use of a clustering model divides the database table into a plurality of smaller portions (clusters, segments) which for their part can be regarded as separate database tables and are more efficient to handle on account of the smaller size.

More efficient statistical evaluation of the database table using a clustering model can be achieved, by way of example, by checking, during the statistical evaluation of the database table, whether a prescribed selection condition results in it being possible to tell from the statistical model that all the data which meet the selection conditions are located in a single cluster or a subset of the clusters. If this is true then it is possible to limit oneself to these clusters during the evaluation. Equally, it is possible to limit oneself to clusters in which the data meeting the prescribed condition have at least a certain relative frequency of being included. The other clusters, which contain data only in a lower proportion in line with the prescribed condition, can be disregarded if only approximative statements are desired.

The statistical clustering model used is a Bayesian clustering model (a model with a discrete latent variable), for example.

This is described more precisely below.

Assume a set (K-tuple) of random variables (statistical variables) X=(X₁, . . . , X_{K}). The possible states (forms) of the random variables are described by the respective lower-case letters. The i-th (1≦i≦K) random variable Xᵢ can thus assume the states x_{i,1}, x_{1,2}, . . . , X_{i,Li}, for example, where Lᵢ is a natural number greater than or equal to one.

It is possible to use both discrete and continuous (real-value) random variables.

In this exemplary embodiment, continuous states are discretized using appropriate discretization intervals. Accordingly, it is assumed that the states of the random variables x_{i,1}, x_{i,2}, . . . , X_{i,Li} (for all i, where 1≦i≦K) are discrete.

A data record in the database table contains a value (form) for each of the random variables X₁, . . . , X_{K}. The π-th data record in the database table can accordingly be written in the form

$${\underline{x}}^{π} = ( {x}_{1}^{π} , … , {x}_{K}^{π} )$$

where xᵢ^{π}ε{x_{i,1}, . . . , x_{i,Li}} for all 1≦i≦K.

As an example, when written beneath one another, the data records form a database table (or table) which has a column for each random variable.

It is assumed that the table contains M entries. The entire database table can therefore be written as a matrix

D=(x^{π})π=1, . . . , M.

When using a clustering model, what is known as a hidden variable (cluster variable), denoted by Ω, is additionally used. The cluster variable has one of the values ωᵢ (i=1, . . . , R) for each data record in the database table. The value of the variable Ω for a data record indicates the cluster (segment) with which the data record is associated within the context of the clustering model. In this example, there are therefore R different clusters.

P(Ω|θ) denotes the a-priori distribution of the clusters, with P(ωᵢ|θ=θ) indicating the a-priori weight of the i-th cluster. That is to say that P(ωᵢ|θ=θ) is the probability of a (random) data record in the database table belonging to the i-th cluster. The a-priori distribution describes what proportion of the data is associated with the respective clusters.

The set of random variables θ can assume the possible parameter vectors θ of the statistical model.

Let P(X|Ω=ωᵢ, θ=θ) be the conditional probability distribution within the i-th cluster, that is to say the probability distribution of the random variable X=(X₁, . . . , X_{K}) within the i-th cluster.

The a-priori distribution P(Ω|θ) and the distributions of the conditional probabilities P(X|ω=ωᵢ, θ=θ) (for each cluster) together form a probability model P(X,Ω|θ) for (X₁, . . . , X_{K}, Ω).

The probability model is given by the product of the a-priori distribution and the conditional probability distribution, that is to say:

P(X|Θ)=P(Ω|Θ)·P(X|Ω,Θ)

or

$$P ( \underline{X} \vert \underline{Θ} ) = {\sum }_{i = 1}^{R} P ( Ω = {ω}_{i} \vert \underline{Θ} ) \cdot P ( \underline{X} \vert Ω = {ω}_{i} , \underline{Θ} )$$

that is to say

$$\begin{matrix}P ( \underline{X} = ( {x}_{1} , … , {x}_{k} ) \vert \underline{Θ} = \underline{ϑ} ) = {\sum }_{i = 1}^{R} P ( Ω = {ω}_{i} \vert \underline{Θ} = \underline{ϑ} ) \cdot \\ P ( \underline{X} = ( {x}_{1} , … , {x}_{k} ) \vert Ω = {ω}_{i} , \underline{Θ} = \underline{ϑ} )\end{matrix}$$

The probability P(Ω=ωᵢ|θ=θ) means the weight of the i-th cluster (segment).

The logarithmic likelihood function L of the parameter vector θ of the data record D is assumed to be given by

$$L ( \underline{ϑ} ) = log P ( \underline{D} \vert \underline{Θ} = \underline{ϑ} ) = {\sum }_{1 \leq π \leq M} log P ( \underline{X} = {\underline{x}}^{π} \vert Θ )$$

Within the context of the Expectation Maximization (EM) learning, a sequence of parameter vectors θ^{(t)} is now constructed in line with the following general specification:

$${\underline{ϑ}}^{( t + 1 )} = {arg max}_{\underline{ϑ}} {\sum }_{1 \leq π \leq M} {\sum }_{1 \leq i \leq R} P ( {ω}_{i} \vert {x}^{π} , {\underline{ϑ}}^{( t )} ) \cdot log P ( {x}^{π} , {ω}_{i} \vert \underline{ϑ} )$$

This iteration specification is used to maximize the likelihood function on a step by step basis and to determine a suitable parameter vector θ, which specifies the statistical model. Each of the iteration steps comprises an E step and an M step. The E step corresponds to the right-hand portion of the above equation. In this case, for each of the M data records the expected values or the a-posteriori probability P(Ω|X=x, θ=θ) for the cluster variable Q is calculated on the basis of the current parameters, i.e. the cluster association of the data record is estimated. In the M step, the new parameters are then set in line with the above equation.

After the parameter vector θ has been learnt (following the convergence of the above iteration), each data record x^{π} is associated with a cluster (segment).

In this context, the association is made using the a-posteriori distribution P(Ω|X=x, θ=θ). The data record x is in this case associated with the i-th cluster whose weight is highest, that is to say when the following is true:

$$P ( {ω}_{i} \vert \underline{X} = {\underline{x}}_{r} \underline{Θ} = \underline{ϑ} ) = {max}_{1 \leq j \leq R} P ( {ω}_{j} \vert \underline{X} = {\underline{x}}_{r} \underline{Θ} = \underline{ϑ} ) .$$

The cluster association of each data record can be stored in an additional field of the data record in the database table, and appropriate indexes can be prepared in order to be able to access the data which belong to a particular cluster quickly.

If, by way of example, a statistical query in the form “Output all data records where X₁=x_{1,1} and X₂=x_{2,3}, and also the associated distributing over X₃ and X₄ (that is to say P(X₃|X₁=x_{1,1}, X₂=x_{2,3}) and P(X₄|X₁=x_{1,1}, X₂=x_{2,3}))” is made to the database table then the procedure is as follows:

First of all, the a-posteriori distribution P(Ω|X₁=x_{1,1}, X₂=x_{2,3}) is ascertained. This distribution reveals (possibly only approximately) what proportion of the data can be found in which clusters of the database table in line with the imposed condition. Thus, it is possible in all further operations, depending on the desired accuracy, to limit oneself to the portions (clusters) of the database table which have a high a-posteriori weight in line with P(Ω|X₁=x_{1,1}, X₂=x_{2,3}) and hence, as an example, contain a large portion of the data which are relevant (in line with the imposed condition).

An ideal situation arises when P(ωᵢ|X₁=x_{1,1}, X₂=x_{2,3})=1 for one i and accordingly P(ωⱼ|X₁=x_{1,1}, X₂=x_{2,3})=0 for all j≠i, that is to say when all the data corresponding to the imposed condition are included in a single cluster.

In such a case, a restriction to the i-th cluster can be made without any loss of accuracy in the further evaluation. In this case, use is made of the property of the cluster models described here that the a-posteriori probability of a cluster for a selection condition is 0 only if the cluster does not contain a single data record which meets the condition. In this respect, the models are therefore exact.

Besides the identification of the relevant clusters, the statistical model can also be used for direct calculation of certain desired probabilities (possibly approximately). To determine probability distributions for X₃ and X₄, for example, the desired distributions P(X₃|X₁=x_{1,1}, X₂=x_{2,3}) and P(X4|X₁=x_{1,1}, X₂=x_{2,3}) can be ascertained approximately on the basis of the parameters of the model, for example in line with

$$P ( {X}_{3} \vert {X}_{1} = {x}_{1 , 1} , {X}_{2} = {x}_{2 , 3} ) = {\sum }_{1 \leq i \leq R} P ( {X}_{3} \vert Ω = {ω}_{i} , {X}_{1} = {x}_{1 , 1} , {X}_{2} = {x}_{2 , 3} , Θ = ϑ ) \cdot P ( Ω = {ω}_{i} \vert {X}_{1} = {x}_{1 , 1} , {X}_{2} = {x}_{2 , 3} , Θ = ϑ )$$

Alternatively, the statistical model can also be used just to ascertain the clusters which are relevant to the current query, however.

Following restriction to the relevant clusters, more accurate methods can be used within the clusters. By way of example, exact counting of the statistics within the cluster can take place, for example when the data have been organized (and possibly compressed) according to cluster association in the memory or on disk or using an additional index for the cluster association. Within the clusters, it is then possible to use simple counting methods in the main memory, conventional database reporting methods or OLAP (online analytical processing) methods, or further statistical models specifically matching the clusters can be used. A close link to OLAP is of particular advantage, since the “sparsity” of the data in high dimensions is utilized by the statistical clustering model, and OLAP methods are used only within the effectively lower-dimensional cluster.

The restriction to relevant clusters is of particular advantage if the clusters are in compressed form in a database image, as explained below. In this case, it is not necessary to decompress the entire database image, that is to say all the clusters, for a query.

The tradeoff between speed and accuracy for the evaluation is obtained from the volume of the data excluded from the evaluation: the more clusters are excluded from the evaluation, the faster, but also the less accurately, the response to a statistical query will be. The user can be provided with the opportunity to determine the tradeoff between accuracy and speed himself. In addition, automatic more exact methods can be initiated if the evaluation of the model reveals insufficient accuracy.

In general, clusters which are below a certain minimum weight are excluded from the evaluation. Exact results can be achieved by excluding from the evaluation only those clusters which have an a-posteriori weight of zero.

Overtraining of a clustering model is of no importance because the most exact reproduction of historic data possible is desired and not a forecast for the future. Nevertheless, severely overtrained clustering models tend to provide the most explicit association possible between queries and clusters, which is why a restriction to small portions of the database table is possible very quickly in the case of further operations.

Advantageously, when a data storage medium is used, the data associated with a cluster are stored in a manner which corresponds to the cluster association.

By way of example, the data associated with a cluster can be stored in one section of the memory 104, so that the associated data can be read quickly in blocks.

As mentioned, random variables which assume continuous values can be discretized. By way of example, an “income” random variable, that is to say a random variable which corresponds to the statement in the customer data records for the income of the respective customer, can be classified into classes of income. The classification into classes of income can be made with various degrees of fineness or coarseness, according to the analytical requirements, that is to say according to the requirements for the accuracy by means of which the database image is intended to reproduce the database table, that is to say is intended to contain the information from the database table.

For a very accurate representation of an originally continuous quantity, the variable can first of all be discretized into intervals. In addition to the discrete variable resulting therefrom (which is compressed as in the methods described here), the average value of each interval can additionally be stored, and for each discrete value the discrepancy from the average value. Since it is then necessary to store only small differences, this can be done with very efficient use of memory.

The forms of categorical variables are encoded accordingly, for example for a “sex” random variable the form “male” is encoded by means of zero and the form “female” is encoded by means of a one.

If a categorical random variable in the database table has a large number of forms, these can be grouped into classes when the data image is produced, provided that this is permitted by the requirements for the database image.

First, the product directory for the aforementioned construction market could be organized hierarchically, for example the product labeled “zinc-coated M4 screws” could belong to the product group “Machine screws”. The product group “Machine screws” could for its part be associated with the product group “Screws”, which for its part is associated with the product group “Tool accessories”, “Tool accessories” itself being a product subgroup of the product group “Tools”. On the basis of the requirements for the database image, it might now be sufficient not to distinguish different machine screws but rather to combine them to produce a class “Machine screws”. Accordingly, each transaction data record in the transaction database table image 108 has the entry “Machine screws” (or a value associated with this form) in the field corresponding to the product statement, for example, if the relevant transaction data record in the transaction database table 106 contains the specification for any machine screw in the field which corresponds to the product statement.

A query to the database image can now be handled on the basis of this classification of the categorical variable into classes. If more accurate classification of the forms of the categorical variable (for example a distinction between different machine screws) is required in order to answer the query, the database table is used instead. In this case, it is typically now only necessary to request a few detail information items from the database table, however.

Illustratively, the database image can be used to provide approximate responses to statistical queries.

In one embodiment, the database image is of hierarchic design. Illustratively, the clusters produced as described above themselves are regarded as database tables and, in similar fashion to the entire database table, are divided into segments, that is to say that each data record in the i-th cluster is associated with a j-th subcluster from a plurality of subclusters of the i-th cluster. Continuing in similar fashion, as an example, a tree of clusters and subclusters is constructed by virtue of the j-th subcluster of the i-th cluster itself being associated with a k-th subcluster from a plurality of subclusters from the j-th subcluster of the i-th cluster etc.

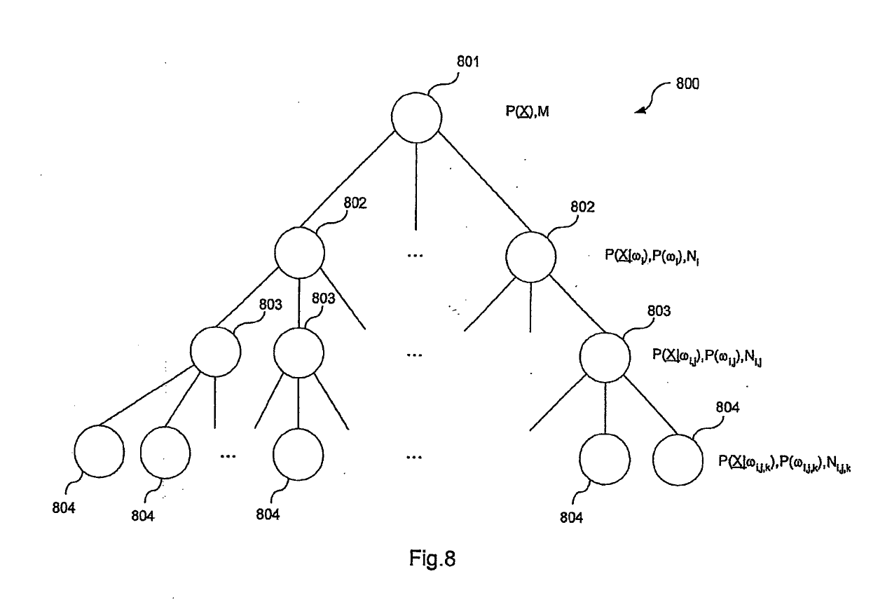

The cluster hierarchy produced in this manner is shown in FIG. 8.

FIG. 8 illustrates a cluster hierarchy 800 in line with a database image based on an exemplary embodiment of the invention.

The cluster hierarchy 800 is in the form of a tree.

The database table 801 is symbolized by the routes of the tree. In line with the example above, the database table has M data records which respectively contain values for the random variable X=(X₁, . . . , X_{K}).

For the database table 801, a statistical clustering model is determined.

The probability distribution for the random variable X=(X₁, . . . , X_{K}) for all the data records (based on the particular statistical clustering model) shall be denoted by P(X). (In contrast to above, there is no indication of a parameter vector θ and accordingly no random variable θ given. It is assumed that the statistical clustering model is specified by an appropriate set of parameters.)

In line with the statistical clustering model, the database table 801 is divided into a first plurality of R₁ clusters 802.

The probability distribution for the data records in the i-th cluster from the first plurality of clusters 802 is given by P(X|ωᵢ). The i-th cluster from the first plurality of clusters 802 shall contain Nᵢ data records. The probability of a cluster belonging to the i-th cluster from the first plurality of clusters 802 shall be P(ωᵢ), where ωᵢ is the value of the cluster variable Ω which corresponds to the i-th cluster from the first plurality of clusters 802.

The clusters from the first plurality of clusters 802 are for their part classified into clusters, so that a second plurality of clusters 803 is produced. The i-th cluster from the first plurality of clusters 802 shall be classified into R_{2,i} (sub)clusters in this case.

The j-th subcluster (which is one of the clusters from the second plurality of clusters 803) from the i-th cluster from the first plurality of clusters 802 shall have the associated value ω_{i,j} for the cluster variable Ω.

The probability distribution for the data records in the j-th subcluster from the i-th cluster from the first plurality of clusters 802 is given by P(X|ω_{i,j}). The j-th subcluster from the i-th cluster from the first plurality of clusters 802 shall contain N_{i,j} data records. The probability of a cluster belonging to the j-th subcluster from the i-th cluster from the first plurality of clusters 802 shall be P(ω_{i,j}).

The clusters from the second plurality of clusters 803 are respectively further divided into clusters in similar fashion to the first plurality of clusters 802, so that a third plurality of clusters 804 is produced for which the quantities P(X|ω_{i,j,k}), P(ω_{i,j,k}) and N_{i,j,k} are defined in similar fashion to above.

The data records in the bottommost level of the cluster hierarchy 800 are stored in compressed form and are stored in the memory 104, for example, as a database image. (The database image has further data in addition to the stored data records, for example the parameter set for the statistical (clustering) model which has been determined.)

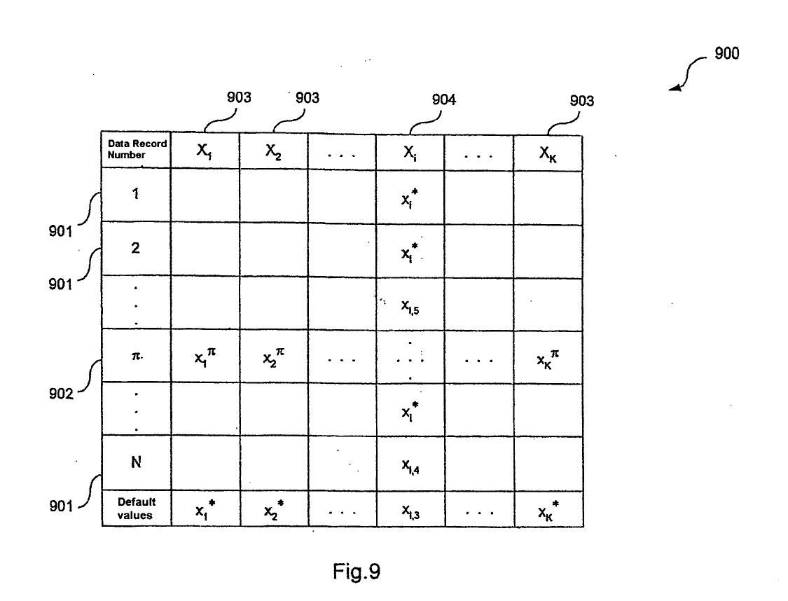

The text below refers to FIG. 9 to explain how the data records for a cluster are compressed and stored.

FIG. 9 illustrates a cluster 900 based on an exemplary embodiment of the invention.

The cluster 900 is shown in the form of a table. Each row from a plurality of N rows 901, 902 corresponds to a data record which the cluster 900 contains.

Each column from a plurality of K columns 903, 904 corresponds to a random variable.

The following is explained by way of example with reference to the π-th row 902 and the i-th row 903.

The cluster 900 shall correspond to the value X of the cluster variable Ω.

As above, the π-th data record is in the form x^{π}=(x₁^{π}, . . . , x_{K}^{π}), where xᵢ^{π}ε{x_{i,1}, . . . , x_{i,Li}} for all 1≦i≦K.

The values x_{i,1}, x_{i,2}, . . . , x_{i,Li} (for all i where 1≦i≦K) are the possible forms of the random variables Xᵢ, Lᵢ for the number thereof. A data record therefore corresponds to a K-tuple of possible forms, the K-tuple at the i-th location having one of the possible forms of the i-th random variable Xᵢ.

The probability distribution for the random variables for the data records in the cluster 900, that is to say the relative frequencies of the K-tupels of forms in the cluster 900, shall be given by P(X|ω) (possibly only as an approximation, depending on how accurate the particular statistical model is).

As above, it is assumed that x_{i,1}, x_{i,2}, . . . , x_{i,Li} (for all i where 1≦i≦K) are discrete values. If the data records in the underlying database table, that is to say in the database table from which the database image was produced, have continuous values then these are discretized. A value x_{i,j} therefore possibly corresponds to a discretization interval.

In line with the determination of a clustering model as explained above, the cluster hierarchy 800 is formed such that the data within the clusters in the cluster hierarchy 800 are more homogenous than all the data in the underlying database table. In particular, for each random variable a value (a form) is distinguished which the data records in the cluster 900 and hence the plurality of rows 901, 902 contain most frequently (or relatively frequently).

The distinguished value for the i-th random variable Xᵢ (also referred to as the default value for the i-th random variable or as the representative value) shall be denoted by x*ᵢ. The default value can be calculated using the statistical model, that is to say that the forms contained in the data records do not each have to be counted in order to determine their respective relative frequency.

For a default value, it is true, as an example, that the conditional probability P(Xᵢ=x*ᵢ|ωᵢ) is relatively high, that is to say that it can be assumed in the i-th cluster that the i-th random variable has the value x*ᵢ.

By way of example, it might be true that 90% of all (registered) male customers between the ages of 30 and 40 in the aforementioned construction market have a call account (to see this, the customer database table 105 must contain the information regarding whether the customers have a call account). For this class of customers, it is thus possible to assume with a high level of certainty that they (each) have a call account. If it now also turns out during the production of the clustering model that a cluster predominantly comprises customers of this type, for example that the customers in this cluster are 85% male, and 95% between 30 and 40 and that 92% of them have a call account, then the default value “yes” is used (with “yes” being encoded by the value 1, for example) for the call account random variable, that is to say the entry regarding whether the relevant customer has a call account.

Illustratively, the value of the cluster variable Ω for a cluster can therefore be used to predict the data records in the cluster, in this example for the value of the random variable indicated whether the relevant customer has a call account.

In this exemplary embodiment, the data records in the cluster 900 are compressed on the basis of the basic principle that only the discrepancy between a form of a random variable and the relevant default value is stored. This is done using run length encoding, for example.

Illustratively, information is encoded only if it differs from the expectations corresponding to the statistical model.

The text below explains the column-by-column runlength encoding of the data records which the cluster 900 contains.

The i-th column is runlength encoded. By way of example, the i-th column shall contain the values

x*ᵢ, x*ᵢ, x_{i,5}, x_{i,2}, x*ᵢ, x*ᵢ, x*ᵢ, x*ᵢ, x_{i,1}, x*ᵢ, x*ᵢ, x*ᵢ, x_{i,4}.

In this case, it has been assumed that Lᵢ≧5. By way of example, x*ᵢ=x_{i,3} could be true.

In the case of the run length encoding based on this exemplary embodiment of the invention, the default value x*ᵢ is not encoded, but rather only how often it occurs in successive rows is encoded. Accordingly, the i-th column is encoded to produce

### 2, X_{i,5}, 0, x_{i,2}, 4, x_{i,1}, 3, x_{i,4}.

In another embodiment, the number of successive rows which contain the default value has one added to it, so that the encoded column has the form

3, x_{i,5}, 1, x_{i,2}, 5, x_{i,1}, 4, x_{i,4}.

Rapid access to the encoded column does not require this column to be decoded. Illustratively, it is possible to work on the data in encoded form directly, so that queries can be answered more quickly than if the compression is reversed in the case of a query (which would result in a higher level of computation complexity).

The text below explains a few examples of access to the encoded column.

By way of example, it is possible to determine, without decoding the encoded column, what data records in the i-th column have a different value than the default value. In the case of a corresponding query, the result is provided in accordance with table 1.

TABLE 1

| Position of the | |
|---|---|
| data record | Value |
| 3 | x_{i,5} |
| 4 (3 + 1) | x_{i,2} |
| 9 (4 + 5) | x_{i,1} |
| 13 (9 + 4) | x_{i,4} |

Similarly, it is possible to determine, without decoding the encoded column, what data records in the i-th column contain the default value. In the case of a corresponding query, the result shown in table 2 is supplied.

TABLE 2

| Position of the | |
|---|---|
| data record | Value |
| 0 < n < 3 | xᵢ* |
| 4 < n < 9 | xᵢ* |
| 9 < n < 13 | xᵢ* |

In addition, it is possible to determine, without decoding the encoded column, what data records in the i-th column contain the value x_{i,1}, for example. In the case of a corresponding query, the result shown in table 3 is supplied.

TABLE 3

| Position of the | |
|---|---|
| data record | Value |
| 3 + 1 + 5 = 9 | x_{i,j} |

In another embodiment, the cluster 900 is encoded arithmetically in columns.

Arithmetic encoding (see [4], for example) is a compression method in which a data stream is converted into a bit representation of a real interval. This involves the use of a prescribed probability distribution.

The probability distribution is used to determine the probability of the next value in the data stream being the value x, P(next value=x).

In the present case, the data stream is formed by the i-th column 904 (or by all the columns written after one another). The probability P (next value=x) is ascertained using the determined statistical clustering model. The compression is then performed accordingly by an arithmetic compressor.

In this embodiment, however, it is necessary to decode the encoded column in order to answer queries (such as the ones above).

In another embodiment, a combination of runlength encoding and arithmetic encoding is used.

In a first step, the i-th column, for example given by

x*ᵢ, x*ᵢ, x_{i,5}, x_{i,2}, x*ᵢ, x*ᵢ, x*ᵢ, x*ᵢ, x_{i,1}, x*ᵢ, x*ᵢ, x*ᵢ, x_{i,4}
is encoded in similar fashion to above by 3, x_{i,5}, 1, x_{i,2}, 5, x_{i,1}, 4, x_{i,4}, where, as above, the values 3, 5 and 4 each indicate the runlength of the default value plus one at the relevant location in the data stream.

Next, the data stream 3, x_{i,5}, 1, x_{i,2}, 5, x_{i,1}, 4, x_{i,4} is compressed further using arithmetic encoding. The probability distribution used for this is given as follows: probabilities for the values which indicate the runlength are given by

P(runlength=n)=P(next value in the data stream=x*ᵢ)ⁿ⁻¹(1−P(next value in the data stream=x*ᵢ)).

Probabilities for values xᵢ≠x*ᵢ are given by

P(next value in the data stream=xᵢ)=P(next value in the data stream=xᵢ)/(1−P(next value in the data stream=x*ᵢ)).

However, this embodiment also requires the encoded column to be decoded in order to answer queries (such as the ones above).

In another embodiment, the procedure is not column by column but rather row by row. In similar fashion to the column-by-column procedure, the above options are available (runlength encoding, arithmetic encoding, combination of runlength encoding and arithmetic encoding).

If arithmetic encoding is used for row-by-row procedures, the compression rate can be increased further by using conditional probabilities for the probability distribution which is used for the arithmetic encoding.

If the π-th row x^{π}=(xᵢ^{π}, . . . , x_{K}^{π}) is compressed, for example, then for the probability of the i-th component x*ᵢ having the value xᵢ^{π} it is possible to use the probability

P(xᵢ=xᵢ^{π}|x₁=x₁^{π}, . . . , xᵢ₋₁=xᵢ₋₁^{π})

which can be ascertained using the determined statistical clustering model.

In summary, as an example, the ascertained statistical (clustering) model is used to achieve compression of the database table (provided that the memory space saved is greater than the memory space required to store the statistical model). The cluster hierarchy 800, as shown in FIG. 8, is in one embodiment constructed to the extent that further segmentation (that is to say division into clusters) of the bottommost level of clusters (in FIG. 8 from the third plurality of clusters 804) does not allow any additional memory space to be saved (since the memory space required to store the statistical model compensates for the additionally achieved compression in this case).

Regardless of what method is used to compress the cluster 900, the cluster 900 can then be compressed in a second step using a further compression method, for example using a Lempel-Ziv compression method, in order to eliminate any redundancies which continue to exist. Since one of the aforementioned compression methods has already been used to compress the cluster, the second step may involve the use of complex compression methods without requiring an unacceptable level of computation complexity for the compression and/or decompression.

In addition, methods for encoding sparsely used tables (sparse encoding) may be used.

The statistical methods for compression and the data structures produced in this context have not only a positive effect on the size of a database image. The data structures can also easily be used to calculate analytical queries more quickly. If, for a variable, for example, a value is encoded only if it differs from the default value then when the statistics about the various values are ascertained it is also only necessary to make corrections by a default statistic for all currently selected data records, in line with each encoded discrepancy from the default value.

The encoding of the cluster 900, or of the data records which the cluster contains, for example on the basis of one of the exemplary embodiments explained above, allows a key to be stored in the data image for each data record which the cluster 900 contains, said key being able to be used to find the relevant data record in the underlying database table.

Each data record in the underlying database table has an associated key. The database image of the database table contains this key for each data record stored in compressed form as explained above.

As the key which is stored for each data record in the database image, it is also possible to use a “natural key” for the segmentation, however, that is to say that the key used for a data record in the cluster 900 is a combination of a first key, which specifies the cluster number of the cluster 900, and a second key, which corresponds to a number for the data record in line with numbering of the data records which the cluster 900 contains. As an example, the second key is therefore the number of the data record within the cluster 900. The cluster number of the cluster 900 may be a hierarchic cluster number which is formed on the basis of the cluster hierarchy 800. By way of example, the subclusters from a cluster can be numbered continuously, and accordingly the subclusters from such a subcluster can again be numbered continuously, so that the result is a hierarchic cluster number for the cluster 900 in the form 1/3/2, for example, if the cluster 900 is the second subcluster (in the third plurality of clusters 804) from the third subcluster (in the second plurality of clusters 803) from the first cluster from the first plurality of clusters 802.

The second key, which corresponds to a number for the data record in line with numbering of the data records which the cluster 900 contains, can typically be chosen to be very short (one byte or a few bytes in length), since the cluster 900 contains only a few data records on account of the segmentation.

The use of this “natural key” has the advantage that only little storage complexity arises for storing keys for data records in the database image.

The association between the “natural keys” and the keys used in the underlying database table (which is required in order to find the data record which corresponds to a data record in the database image in the database table) can be stored in the form of a database table in the database, which contains the database table, itself and can be read accordingly upon access to the database table or to the database.

If there are a plurality of database tables and accordingly database images, for example in line with FIG. 1 a transaction database table image 108 for a transaction database table 106 and a customer database table image 107 for a customer database table 105, then the database images are used to store keys for the respective data records.

In the example shown in FIG. 1, it is now possible, as was explained with reference to FIG. 4 and FIG. 5, to select appropriate customer data records in the customer database table image 107 for selecting transaction data records in the transaction database table image 108 (for example as shown in FIG. 4). This is done using a common key for the customer database table 105 and for the transaction database table 106, for example using the customer number of a customer to which a customer data record corresponds, or corresponds to a customer who was involved in a transaction corresponding to a transaction data record.

When selecting transaction data records in the transaction database table image 108 (for example as shown in FIG. 4), the keys stored in the transaction database table image 108 for the transaction data records in the transaction database table image 108 can be used to identify the corresponding transaction data records in the transaction database table 106 (for example using an appropriate association table). The customer numbers can now be used to determine the correspondingly selected customer data records in the customer database table 105, and an association table associating the relevant keys for the customer data records in the customer database table 105 with the keys for the customer data records in the customer database table image 107 can be used to ascertain the correspondingly selected customer data records in the customer database table image 107 and to use the appropriate selection (for example as shown in FIG. 5).

So that it is not necessary to access the customer database table 105 and the transaction database table 106 in order to ascertain the relevant selection of the customer data records in the customer database table image 107, the transaction database table image and the customer database table image 107 themselves have a common key (for example customer numbers) which allow the appropriate selection of customer data records in the customer database table image 107 for a selection of transaction data records in the transaction database table image 108 in similar fashion to the procedure described above.

Thus, the proposed method has the following advantages particularly in connection with relational queries (that is to say queries which relate to a plurality of database tables). The compression allows the database images to be kept in a small but fast memory (in the main memory). At the same time, the database images are designed such that keys can be stored in the compressed images and nevertheless still allow (almost) random access. This allows various database images (like originally different tables (database tables) in the relational database) to be connected by means of keys and hence allows relational queries to be answered. This means a considerable gain in speed is obtained for the following reasons:
the speed of the main memory is substantially higher than that of other large mass memories (hard disks).
the database images are designed such that the segmentation allows rapid access to the data and rapid counting.
the main memory allows what is known as random access (unlike hard disks), which is particularly advantageous when specific access to elements in different images is required by means of keys in the case of relational queries.

Additionally increased efficiency is obtained in an embodiment in which a database image (for example the transaction database table image 108) contains references to the data records in the other database image (for example the customer database table image 107).

In another embodiment, an increase in efficiency is achieved by virtue of the two database images not being generated independently of one another but rather the grouping of data records into clusters to produce one of the two database images being effected in consideration of the other database image.

By way of example, the transaction database table image 108 is produced in consideration of the customer database table image 107 by virtue of all transaction data records which correspond to the same customer data record, that is to say which correspond to transactions in which the same customer was involved, being associated with the same cluster. This allows rapid access to the relevant transaction data records in the transaction database table image 108, for example when selecting customer data records in the customer database table image 107, since these are all associated with the same cluster of the transaction database table image 108. This is of particular advantage when the clusters of the transaction database table image 108 are in compressed form and need to be decompressed for access. In the case of grouping carried out as above, it is therefore necessary to decompress only a few clusters for a query.

A tuned cluster structure can be achieved, by way of example, by first of all generating clusters for a table (i.e. database table) using a learning method, as usual. All data from the second table which, in line with the keys, belong to a cluster from the first table are then combined into a cluster for the second table without using a learning method. In the example, the customers are thus first of all combined into typical customer classes (i.e. clustering of the data records in the customer database table is performed). The transaction data records for all the transactions which belong to the customers in a customer class are then accordingly combined into a cluster for the transaction data. Learning accordingly takes place only on the first table. The clustering on the second table is dependent on the clusters from the first table.

Advantageously, common clustering can also be achieved through common learning, however. Common clustering can be achieved through common EM steps in an EM learning method, for example, with a common cluster variable being used. As described above, an EM learning method first of all involves estimating the cluster associations (E step). In a common EM learning method, a customer from a customer table, for example, is associated with a cluster not just on the basis of his customer properties but also on the basis of his transactions (stored in the transaction table). For the transactions belonging to a customer, there are conversely no different a-posteriori estimates for the cluster association but rather a common association.

More specifically, the common clustering can be carried out as follows, for example. To obtain the a-posteriori estimate for the latent variable (the cluster variable) for a customer, a message from each of the known variables (or from variable groups or cliques) for the customer from the customer table is first of all sent to the cluster variable as in known inference methods (see the inference methods described in [10] using message passing algorithms, for example). In this case, as usual, the probability tables are used in line with the structure of the selected customer model. In an additional step, a message is now also sent to the cluster variable from each entry from the transaction table belonging to the currently considered customer in order to take account of the information from the transaction table in the a-posteriori estimate of the association of a customer with a cluster. For each transaction belonging to a customer, repeated use can then be made of the probability tables for a chosen “transaction model” (a common probability model for the variables from the transaction table and the latent variable). The a-posteriori estimate thus produced for the cluster variable can then form the basis for the M step. In the customer model, this is the usual M step using the jointly calculated posterior for each customer and calculation of the “sufficient statistics” (see [1] and [3]) as a sum over all customers. In the transaction model, the calculation of the sufficient statistics for the M step can be effected as a sum over all transactions for a customer with the associated posterior and as an additional sum over all customers.

If a database image contains keys as described above, the database image can be used as a multidimensional index for a database. This is explained below. In particular, a plurality of database images connected by means of a key allow multidimensional access to a database in which conditions are set for dimensions from various database tables.

For a database table, an index can be produced for a column of the database table which allows rapid finding of data records in the database table for which the quantity stored in the column assumes a particular value. By way of example, the customer database table 105 might have a column which indicates the nationality of the customers, that is to say that each customer data record has a field which contains a specification of the nationality of the relevant customer. If country-specific queries to the customer database table 105 are frequently made then it is advantageous to combine the keys from customer data records corresponding to customers of a particular nationality in an index (that is to say a list). In this way, the customer data records corresponding to customers of the nationality can quickly be found in the database table. Thus, an index can be created for each column of the database table. If the database table has a large number of columns, however, then a considerable amount of complexity arises which results in performance difficulties, in particular. In the extreme case, it is not possible, for example for performance reasons, to generate an index for each column of the database table.

A database image can be used as a “multidimensional” index for the database table if, as explained above, keys are stored for the data records in the database image which allow the relevant data records to be found in the underlying database table. Thus, for each selection of data records in the database image, the relevant data records can be found in the underlying database table on the basis of prescribed properties without the need to check the prescribed conditions for all the data records in the database table.

This is advantageous particularly when only a small portion of the data meets the selection criteria and therefore only a few data records need to be retrieved from the database table but without the database image it would have been necessary to examine all the data records in order to check whether they met the selection conditions.

By way of example, the customer database table contains, for each (registered) customer in the construction market, a customer data record which, besides the age of the customer, the customer number, the sex of the customer (etc.), contains the address of the customer. In the customer database table image 107, there is, for each customer, a customer data record which contains just a portion of this information, for example the sex of the relevant customer and the age of the relevant customer, but particularly not the address of the relevant customer. At the end of a planning process, a target group might now have been determined, for example all customers between 30 and 40 with a particular income who are single. The customer database table image 107 can now be used as a multidimensional index for the customer database table 105 in as much as the customer data records in the customer database table 105 which correspond to the target group can be quickly ascertained using the keys stored in the customer database table image 107. The customer database table image outputs the appropriate keys, and the keys are forwarded to the database. Using the keys, the database can immediately retrieve the addresses of the customers in the target group from the customer database table 105 without having to use a complex process to check the condition which defines the target group for all customer data records.

Using database images relationally linked by means of a database key, it is similarly also a very quick matter to retrieve data records (target groups) from a database which define themselves by means of a condition to which various database tables in a database relate. Thus, by way of example, addresses can very quickly be ascertained from a database for customers who are between 30 and 40 years old (=condition for a field from the database table with the customer master data) and who have purchased bulbs in January (=condition for a field from the transaction table).

As already mentioned above, the forms of a categorical random variable which exist in the database can be grouped in the database image, so that less memory is required particularly for the database image, since fewer different forms need to be encoded. By way of example, as explained above, all possible machine screws are combined into a product group “Machine screws”. Similarly, the database image can contain discretized instances for forms which exist in the database, or various values in the database image can be combined into value ranges.

By way of example, the customer database table 105 contains, in each customer data record, the information regarding the month in which the relevant customer was born, so that the age of the relevant customer is known to an accuracy of one month. To achieve a low memory requirement for the customer database table image 107, the customer data records in the customer database table image 107 each have the specification of the age of the relevant customer just to an accuracy of one year.

If the database image is sent a query which requires the precise information contained only in the underlying database table, the database image can be used to preselect the data records, the keys stored in the database image can be used to determine the data records in the underlying database table which correspond to the preselection, and then the query can be answered by accessing the database table, with only the data records in the database table which correspond to the preselection needing to be taken into account, which achieves a speed advantage.

By way of example, the customer database table image 107 is sent a query which relates to all customers under 17.5 years old. In the customer database table image 107, the age of the customers will be known only to the year in the data records based on the example above. The customer database table image 107 can be used to answer the query for all customers under 17 years old, since the relevant data records can be determined explicitly. In addition, the customer database table image 107 is used to determine the keys for the customer data records for which the relevant customers are between 17 and 18 years old. Using these keys, the customer database table 105 can now be accessed to check which of these customer data records actually correspond to customers who are under 17.5 years old. Once these have been determined accordingly, the query can be answered in full.

The mode of operation as a multidimensional index is advantageous particularly when a plurality of database tables are involved in the query, that is to say when the addresses of all customers who are under 18 years old and have purchased bulbs in January need to be queried, for example. In the database query language SQL, such queries are referred to as “JOIN”. Particularly queries which require a plurality of database tables to be linked are often slow in databases. A list of the IDs (identifications, for example customer numbers) of such customers can, as already described in detail in the preceding embodiments, be ascertained very efficiently by linking two suitable database images which, for example through statistical modeling, achieve compression which allows the list to be calculated fully in the main memory.

In particular, as an example, a database image can be used as a transparent accelerator for a database. Instead of using a user interface, a program transmits a query to the database image, for example. The query is answered quickly using the database, as explained above, by only accessing the database if this is necessary, since the data in the database image are not sufficient. By way of example, as above, the address of a customer is not stored in the database image, but rather only in the database image's underlying database table in the database or in the database image. This is transparent to the extent that for the program which transmits the query there is no difference between whether the query is answered directly by accessing the underlying database table or whether it is answered using the database image of the database table.

Hence, queries from another piece of software are, as an example, accepted by the database image instead of by the database, are evaluated and are then either answered automatically on the basis of the information stored in the database image (or else a plurality of database images) or—if certain required information is not available in the database image—a possibly optimized query is forwarded to the database, the results fetched, possibly processed further, and the result is transmitted to the querying software. Optimization operations performed may involve selection criteria being removed from the query, for example, and appropriate selections being made through direct actuation of individual data records using a list of keys which is generated from the database image.

In particular, embodiments of the invention can accept and answer queries in the query language SQL (structured query language).

In particular, the SQL query can be transmitted from the querying software to embodiments of the invention and the results can be transmitted back by using one of the interface standards JDBC (java database connectivity) or ODBC (open database connectivity).

In particular, embodiments of the invention can be used transparently as an accelerator, i.e. such that a piece of application software which is designed to access the database directly can be speeded up without intervention by the invention.

This document cites the following publications:
[1] Castillo, Jose Manuel Gutierrez, Ali S. Hadi: “Expert Systems and Probabilistic Network Models”, Springer, New York
[2] Reimar Hofmann: “Lernen der Struktur nichtlinearer Abhängigkeiten mit graphischen Modellen”, [Learning the Structure of nonlinear Dependencies using Graphical Models], Dissertation, Berlin, or David Heckermann, A tutorial on learning Bayesian networks, Technical Report MSR-TR-95-06, Microsoft Research
[3] Martin A. Tanner: “Tools for Statistical Inference”, Springer, New York, 1996
[4] Moffat, A., Neal, R. M., and Witten, I. H.: “Arithmetic coding revisited”, ACM Transactions on Information Systems, vol. 16, pp. 256-294, 1995
[5] WO 00/65479
[6] WO 02/101581
[7] A. Orenstein: “Spatial query processing in an object oriented database system”, in SIGMOD, Washington, D.C., pp. 326-236, 1986.
[8] Ramakrishnan Raghu: “Database Management Systems”, McGraw-Hill, 2002
[9] Charu C. Aggarwal, Philip S. Yu: “The IGrid index: reversing the dimensionality curse for similarity indexing in high dimensional space”, Proceedings of the sixth ACM SIGKDD international conference on Knowledge discovery and data mining, Pages: 119-129, ACM Press New York, N.Y., USA, 2000
[10] Finn V. Jensen: “An Introduction to Bayesian Networks”, Springer, 1996, chapter 4
[11] DE 102 52 445 A1
[12] US 2002/0029207 A1

### LIST OF REFERENCE SYMBOLS

100 Computer arrangement
101 Computer system
102 Database system
103 Microprocessor
104 Memory
105 Customer database
106 Transaction database
107 Customer database image
108 Transaction database image
109 Explorer computer program
110 Screen
111 Input appliances
200 Screen display
201-203 Screen window with analysis results
204 Selection information field
205, 206 Selection window
300 Screen display
301-303 Screen window with analysis results
304 Selection information field
400 Screen display
401-403 Screen window with analysis results
404,405 Bar
406 Selection information field
500 Screen display
501-503 Screen window with analysis results
504 Selection information field
600 Screen display
601-603 Screen window with analysis results
604 Bar
700 Screen display
701-703 Screen window with analysis results
704 Marker
800 Cluster hierarchy
801 Database
802 Plurality of clusters
803 Plurality of clusters
804 Plurality of clusters
900 Cluster
901,902 Rows
903,904 Columns

1. A database query system having
a first database image of a first database table containing a first multiplicity of data records and a second database image of a second database table containing a second multiplicity of data records, where each data record in the first multiplicity of data records and each data record in the second multiplicity of data records has an associated value for a database key;
an input device which is set up to receive an analysis query to the second database image;
a selection device which is set up to select a portion of the first multiplicity of data records in line with a first selection;
an ascertainment device which is set up to ascertain a second selection of a portion of the second multiplicity of data records, wherein in accordance with the second selection such data records are selected which have associated values for the database key which are respectively associated with at least one data record which has been selected in line with the first selection;
a processing device which is set up to ascertain the result of the analysis query on the basis of the portion of the second multiplicity of data records.

2. The database query system as claimed in claim 1, where the first database image and the second database image are produced in line with a statistical model.

3. The database query system as claimed in claim 2, where the statistical model is a graphical probability model.

4. The database query system as claimed in claim 1, where the input device is also set up to receive a selection instruction, and the selection device is set up to select the portion of the first multiplicity of data records in line with the selection instruction.

5. The database query system as claimed in claim 4, which also has a display device which is set up to show a screen display which comprises the display of possible values for at least one random variable for which each of the first multiplicity of data records contains a value, and the selection instruction is the selection of the display of at least one possible value for the random variable, and the first selection involves all the data records in the first multiplicity of data records being selected which comprise the selected at least one possible value.

6. The database query system as claimed in claim 5, where the display device is also set up to show a further screen display which comprises a display of the result of the analysis query, and where the display device is also set up to change between the screen display and the further screen display.

7. The database query system as claimed in claim 1, also having an access device which is set up to access the second database table and to ascertain data which are contained in the second database table's data records selected in line with the second selection, and where the processing device is set up to ascertain the result of the analysis query using the data.

8. The database query system as claimed in claim 1, where the first database image groups the first multiplicity of data records to form a first plurality of segments and the second database image groups the second multiplicity of data records to form a second plurality of segments.

9. The database query system as claimed in claim 8, where the value of the database key for a data record in the first database image comprises a number for the segment which contains the data record and a number for the data record in line with numbering of the data records in the segment.

10. The database query system as claimed in claim 9, where the value of the database key for a data record in the second database image comprises a number for the segment which contains the data record and a number for the data record in line with numbering of the data records in the segment.

11. The database query system as claimed in claim 10, where each data record in the first multiplicity of data records has the value of the database key stored for it in the first database table and each data record in the second multiplicity of data records has the value of the database key stored for it in the second database table.

12. A method for computer-aided database querying using a first database table containing a first multiplicity of data records and a second database table containing a second multiplicity of data records, where each data record in the first multiplicity of data records and each data record in the second multiplicity of data records has an associated value for a database key, having the following steps:
an analysis query to the second database table is received;
a portion of the first multiplicity of data records is selected in line with a first selection;
a second selection of a portion of the second multiplicity of data records is ascertained, wherein in accordance with the second selection such data records are selected which have associated values for the database key which are also respectively associated with at least one data record which has been selected in line with the first selection;
the result of the analysis query is ascertained on the basis of the portion of the second multiplicity of data records.
